(19) United States
(12) Patent Application Publication
(10) Pub. No.: US 2005/0289518 A1
(43) Pub. Date: Dec. 29, 2005

(54) Compiler and logic circuit design method

(76) Inventors: Tadaaki Tanimoto, TOKYO, CA (JP); Masurao Kamada, Higashimurayama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/531,287

(22) PCT Filed: Oct. 7, 2003
(86) PCT No.: PCT/JP03/12839

§ 371 Date: Apr. 14, 2005

(30) Foreign Application Priority Data
Oct. 15, 2002 (JP) 2002-300073

(51) Int. Cl. G06F 9/45

(52) U.S. Cl. 717/136

(57) ABSTRACT

A compiler in which pseudo C descriptions (1) that are capable of describing parallel operations at a statement level and at a cycle precision by clock boundaries and register assignment statements are input, the register assignment statements are identified (S2), so as to generate executable C descriptions (3), to extract state machines having undergone reductions in the numbers of states, and to decide whether or not a loop to be executed in the 0th cycle is existent (S5), and if the loop is nonexistent, circuit descriptions (4) that are capable of being logically synthesized are generated. Thus, the pseudo C descriptions in which the clock boundaries are explicitly inserted into the C descriptions are input, and the pseudo C descriptions which permit the register assignment statements to be described in parallel at the statement level are input, so that a pipeline operation attended with a stall operation can be represented.

### FIELD OF THE INVENTION

The present invention relates to technology in which program descriptions for a simulation or circuit descriptions for specifying hardware are automatically generated from program descriptions. By way of example, it relates to technology which is effective when applied to the design of a logic circuit executing a pipeline operation, for example, a logic circuit such as CPU (Central Processing Unit).

### BACKGROUND OF THE INVENTION

There has been technology for generating the circuit descriptions of a digital circuit with a program language. A technique stated in Patent Document 1 includes a collective assignment part according to which variables are classified into ones indicative of registers and ones indicative of the inputs of the registers, whereupon the second variables are collectively assigned to the first variables after processing in a module part. A technique stated in Patent Document 2 consists in that parts which are sequentially controlled within a program descriptive of circuit operations in a universal program language are specified in a specification process part, that the descriptions of the parts to be sequentially controlled are thereafter converted so as to operate as state machines, in a conversion process part and by employing the universal program language, that the program after the conversion is acquired, that parts which operate in parallel are subsequently extracted from within the converted program in a program generation process part, and that a program which accesses all the extracted parts is generated.
Patent Document 1: JP-A-2002-49652
Patent Document 2: JP-A-10-149382

### SUMMARY OF THE INVENTION

The method according to Patent Document 1 includes three constituents; (1) modules which indicate circuit operations, (2) the collective assignment part which performs the register assignments, and (3) a loop part which is iterated every clock cycle. It particularly features that the register assignments (2) are executed after obtaining the modules (1), within the loop part (3). However, the modules (1) do not contain clock boundaries, and the clock boundaries are infallibly contained in the loop part (3). Therefore, in order to describe a circuit operation which extends over a plurality of cycles, the circuit operation needs to be divided at the clock boundaries. By way of example, it must be described that, when a certain condition has held, a circuit operation is begun at an intermediate position of a circuit operation executed in a preceding cycle, but the method is difficult of making such a description. It has been found out by the inventors that, especially when a circuit which performs a pipeline operation attended with a stall operation is described by the method stated in Patent Document 1, a complicated job might be involved, program descriptions becoming complicated.

The method according to Patent Document 2 has four features; (1) that the parts to be sequentially processed are identified from within the program described in the universal language and are converted into general-purpose program descriptions expressive of state machines, (2) that parallelism at a function level is extracted, (3) that the association between a program to be turned into hardware and a software program to control the former program is automated, and (4) that, in forming hardware within the parts to-be-sequentially-processed, parts requiring a flip-flop and a latch are identified and are converted into the HDL. However, there is no means for explicitly affording clock boundaries, and descriptions at a cycle precision cannot be directly made. According to an embodiment of Patent Document 2, the clock boundary is set from a function to another function, and it is difficult to describe, for example, that, when a certain condition has held, a circuit operation is begun at an intermediate position of a circuit operation executed in a preceding cycle. It has been found out by the inventors that, especially a circuit which performs a pipeline operation attended with a stall operation can be described by the method stated in Patent Document 2, but that a complicated job might be involved, program descriptions becoming complicated.

An object of the present invention is to provide a compiler which can automatically generate hardware descriptions from program descriptions that explicitly indicate clock boundaries.

Another object of the invention is to provide a compiler which can easily generate the program descriptions or circuit descriptions of a circuit capable of a pipeline operation attended with a stall operation.

Still another object of the invention is to provide a logic circuit design method which can design a circuit capable of a pipeline operation attended with a stall operation.

The above and other objects and novel features of the invention will be clarified from the following description of the specification when read in conjunction with the accompanying drawings.

Typical aspects of the invention disclosed in the present application will be briefly outlined below.

[1] The outline of the present invention will be generally explained. Pseudo C descriptions (1) are input in which parallel operations can be described at a statement level and at a cycle precision by clock boundaries (descriptors $) and register assignment statements (descriptions containing operators=$), the register assignment statements are identified (S2) to generate executable C descriptions (3) (S3 and S4), and to extract state machines having undergone reductions in the numbers of states and to decide whether or not a loop to be executed in the 0th cycle is existent (S5), and if the loop is nonexistent, circuit descriptions (4) which can be logically synthesized are generated (S6).

Owing to the above, the pseudo C descriptions in which the clock boundaries are explicitly inserted into the C descriptions are input, and the pseudo C descriptions which permit the register assignment statements to be described in parallel at the statement level are input, so that a pipeline operation attended with a stall operation can be represented.

The C descriptions which can be compiled by a conventional C compiler can be output on the basis of the pseudo C descriptions. Since the numbers of states are reduced, the circuit descriptions can be output which are accompanied by state machines in the number of states equal to, at most, (the number of clock boundaries afforded by the descriptions+1).

Since functions can be designed at the program level without caring about the state machines, the quantity of descriptions is decreased, so that the design method contributes, not only to shortening the term of a development, but also to enhancing a quality.

Besides, it is permitted to describe a bus interface circuit and an arbitration circuit which cannot be represented by the general descriptions of program level as do not designate the clock boundaries. Especially, since the register assignments are describable, descriptions can be made in consideration of parallelism at the statement level, and a complicated circuit operation such as the pipeline operation attended with the stall operation can be easily described with a smaller quantity of codes than in the C descriptions.

Besides, since the pseudo C descriptions are converted into the C descriptions which are compilable by the conventional C compiler, a high-speed simulation is realized, and the number of man-hour for verifying functions can be sharply diminished. In the function design, accordingly, sharp diminutions in the number of man-hour are realized in both the logic design and the logic verification.

A state machine of Mealy type can be generated from the program descriptions in which the clock boundaries are designated, so that a model inspection at the program level is possible.

The design method is applicable to the development of, for example, a cache controller or a DMA controller of which the cycle precision is required and for which a high-level synthetic tool is unsuitable, and it is greatly contributive to shortening the term of the design.

[2] In the first aspect of a compiler according to the present invention, a compiler can convert first program descriptions (1) described by diverting a predetermined program language, into circuit descriptions (4); the first program descriptions containing register assignment statements (descriptions containing operators=$) and clock boundary descriptions ($) which permit circuit operations to be specified at a cycle precision; the circuit descriptions specifying hardware which realizes the circuit operations specified by the first program descriptions, in a predetermined hardware description language.

In the second aspect of the compiler according to the invention, a compiler can convert first program descriptions described by diverting a predetermined program language, into second program descriptions (3) employing a predetermined program language; the first program descriptions containing register assignment statements (descriptions containing operators=$) and clock boundary descriptions ($) which permit circuit operations to be specified at a cycle precision. The second program descriptions contain transformed assignment statements (13) into which the register assignment statements are transformed so as to be capable of referring to states of preceding cycles, and register assignment description insertion statements (12) which associate variables of the transformed assignment statements with changes of registers attendant upon cycle changes, in correspondence with the clock boundary descriptions.

In the third aspect of the compiler according to the invention, a compiler can convert first program descriptions (1) described by diverting a predetermined program language, into second program descriptions (3) employing a predetermined program language, and circuit descriptions (4). The first program descriptions contain register assignment statements and clock boundary descriptions which permit circuit operations to be specified at a cycle precision. The second program descriptions contain transformed assignment statements into which the register assignment statements are transformed so as to be capable of referring to states of preceding cycles, and register assignment description insertion statements which associate variables of the transformed assignment statements with changes of registers attendant upon cycle changes, in correspondence with the clock boundary descriptions. The circuit descriptions specify hardware which is defined by the second program descriptions, in a predetermined hardware description language.

The predetermined program language is, for example, a C language. The hardware description language is, for example, a description language of RTL level.

[3] The first aspect of a logic circuit design method according to the invention comprises the first step (S1) of inputting first program descriptions (1) which contain register assignment statements (descriptions containing operators=$) and clock boundary descriptions ($) that are described by diverting a predetermined program language in order to define circuit operations on the basis of timing specifications, and that permit the circuit operations to be specified at a cycle precision; and the second step of generating circuit information which satisfies the timing specifications, on the basis of the first program descriptions.

The second step may include the step of converting the first program descriptions, and generating as the circuit information, second program descriptions (3) containing descriptions (13, 12) into which the register assignment statements are transformed using input variables and output variables (S2), and which assign the input variables to the output variables in correspondence with the clock boundary descriptions (S4).

The second step may include the step of converting the second program descriptions, and generating circuit descriptions (4) which serve to specify hardware satisfying the timing specifications, in a predetermined hardware description language, as the further circuit information on the basis of the second program descriptions.

The design method may further comprise the third step of performing a simulation of a circuit to-be-designed by employing the second program descriptions.

Regarding the second step, it is also possible to separately grasp second program descriptions (5) containing descriptions (13) into which the register assignment statements are transformed using input variables and output variables (S2), and third program descriptions (3) containing descriptions (12) which assign the input variables to the output variables in correspondence with the clock boundary descriptions (S4). On this occasion, a simulation is performed on the basis of the third program descriptions by the third step.

[4] The second aspect of the logic circuit design method according to the invention comprises an input step of inputting first program descriptions containing register assignment statements and clock boundary descriptions as are described by diverting a predetermined program language in order to define circuit operations on the basis of timing specifications, and as permit the circuit operations to be specified at a cycle precision (S1); and a conversion step of generating second program descriptions containing descriptions (13, 12) into which the register assignment statements are transformed using input variables and output variables (S2) and which assign the input variables to the output variable in correspondence with the clock boundary descriptions (S4), and being described in the predetermined program language.

The conversion step may well be a step in which, in course of generating a CFG on the basis of the first program descriptions, it sets clock boundary nodes in the CFG in correspondence with the clock boundary descriptions, whereupon it inserts the register assignment descriptions behind the clock boundary nodes.

The design method may well further comprise an optimization step of optimizing codes of the second program descriptions, while a variable table of respective state transitions is being created by utilizing the CFG.

The design method may well further comprise a “retain” step of extracting parts in which variables do not change between states within the variable table, as parts which need to be retained, and adding descriptions for assigning the input variables to the output variables, to the extracted parts.

The design method may well further comprise an extraction step of extracting the codes which constitute state machines, on the basis of the variables and arguments of the respective state transitions within the variable table having undergone the “retain” step.

The design method may well further comprise the step of generating circuit descriptions which describe hardware of a circuit satisfying the circuit specifications, in a predetermined hardware description language, while reference is being had to the state machine constituting codes extracted by the extraction step, and to the second program descriptions.

Whether or not a loop to be executed in the 0th cycle is existent is decided for the first program descriptions, and that, when the loop has been decided to be nonexistent, the conversion step is performed.

### BRIEF DESCRIPTION OF THE DRAWINGS

FIG. 1 is a flowchart exemplifying a logic circuit design method according to the present invention;

FIG. 2 is a block diagram showing a circuit example which is to be designed by applying the design method in FIG. 1;

FIG. 3 is a timing chart showing the operating specifications of the circuit in FIG. 2;

FIG. 4 is an explanatory diagram exemplifying the pseudo C program of the circuit to-be-designed in FIG. 2;

FIG. 5 is an explanatory diagram showing the descriptions of an additional variable declaration and the rewritten descriptions of register assignment statements as are obtained by a register assignment statement identifying process (S2);

FIG. 6 is an explanatory diagram showing one course of a CFG creation process based on pseudo C descriptions;

FIG. 7 is an explanatory diagram showing another course of the CFG creation process based on pseudo C descriptions;

FIG. 8 is an explanatory diagram showing still another course of the CFG creation process based on pseudo C descriptions;

FIG. 9 is an explanatory diagram showing still another course of the CFG creation process based on pseudo C descriptions;

FIG. 10 is an explanatory diagram showing still another course of the CFG creation process based on pseudo C descriptions;

FIG. 11 is an explanatory diagram showing still another course of the CFG creation process based on pseudo C descriptions;

FIG. 12 is an explanatory diagram showing still another course of the CFG creation process based on pseudo C descriptions;

FIG. 13 is an explanatory diagram showing still another course of the CFG creation process based on pseudo C descriptions;

FIG. 14 is an explanatory diagram showing still another course of the CFG creation process based on pseudo C descriptions;

FIG. 15 is an explanatory diagram showing still another course of the CFG creation process based on pseudo C descriptions;

FIG. 16 is an explanatory diagram showing still another course of the CFG creation process based on pseudo C descriptions;

FIG. 17 is an explanatory diagram showing still another course of the CFG creation process based on pseudo C descriptions;

FIG. 18 is an explanatory diagram showing still another course of the CFG creation process based on pseudo C descriptions;

FIG. 19 is an explanatory diagram showing still another course of the CFG creation process based on pseudo C descriptions;

FIG. 20 is an explanatory diagram showing still another course of the CFG creation process based on pseudo C descriptions;

FIG. 21 is an explanatory diagram showing the final course of the CFG creation process based on pseudo C descriptions;

FIG. 22 is an explanatory diagram exemplifying a CFG in which information items on clock boundaries, the start points/end points of branches, and the start points/end points of loops are not affixed to a CFG in FIG. 21, for the brevity of description;

FIG. 23 is an explanatory diagram exemplifying a flag insertion state for the CFG in FIG. 22;

FIG. 24 is an explanatory diagram exemplifying the insertion positions of register assignment description insertion statements on the CFG;

FIG. 25 is an explanatory diagram exemplifying the first ones of executable converted C descriptions (C program) which have been obtained via a C description generation process (S4);

FIG. 26 is an explanatory diagram exemplifying some of the executable converted C descriptions (C program) succeeding to the descriptions in FIG. 25;

FIG. 27 is an explanatory diagram exemplifying the last ones of the executable converted C descriptions (C program) succeeding to the descriptions in FIG. 26;

FIG. 28 is an explanatory diagram showing the first rule of a number-of-states reduction process;

FIG. 29 is an explanatory diagram showing the second rule of the number-of-states reduction process;

FIG. 30 is an explanatory diagram exemplifying results which have been obtained by subjecting the CFG in FIG. 22 to the reduction of the number of states;

FIG. 31 is an explanatory diagram exemplifying a situation where states are assigned to the CFG subjected to the processes of the number-of-states reduction, etc.;

FIG. 32 is an explanatory diagram showing a pseudo C program which is a subject for code optimization, as an example especially simplified for elucidating the process of the code optimization;

FIG. 33 is an explanatory diagram exemplifying a CFG which has been obtained on the basis of the pseudo C program in FIG. 32;

FIG. 34 is an explanatory diagram exemplifying a situation where states are assigned to the CFG in FIG. 33;

FIG. 35 is an explanatory diagram exemplifying the initial situation of a variable table creation process course for state machine generation for the CFG in FIG. 34;

FIG. 36 is an explanatory diagram exemplifying the next situation of the variable table creation process course as succeeds to the situation in FIG. 35;

FIG. 37 is an explanatory diagram exemplifying the next situation of the variable table creation process course as succeeds to the situation in FIG. 36;

FIG. 38 is an explanatory diagram exemplifying the next situation of the variable table creation process course as succeeds to the situation in FIG. 37;

FIG. 39 is an explanatory diagram exemplifying the next situation of the variable table creation process course as succeeds to the situation in FIG. 38;

FIG. 40 is an explanatory diagram exemplifying a variable table which has been generated via the generation course in FIG. 39;

FIG. 41 is an explanatory diagram exemplifying statements to-be-deleted in redundant statement deletions for the variable table in FIG. 40;

FIG. 42 is an explanatory diagram exemplifying the variable table of a result which has been obtained by deleting the redundant statements from FIG. 41;

FIG. 43 is an explanatory diagram showing the result obtained by deleting the redundant statements, in terms of a CFG;

FIG. 44 is an explanatory diagram exemplifying variables to-be-deleted in local variable deletions for the variable table in FIG. 42;

FIG. 45 is an explanatory diagram showing a result obtained by the local variable deletion process, in terms of a CFG;

FIG. 46 is an explanatory diagram exemplifying a variable table which has been finally updated by performing the redundant statement deletion process and the local variable deletion process;

FIG. 47 is an explanatory diagram exemplifying a situation where the description of “retain” has been added to a variable table by a “retain” analysis being a later process;

FIG. 48 is an explanatory diagram showing an example in which arithmetic formulae have been further simplified as the optimization of codes, in terms of a CFG;

FIG. 49 is an explanatory diagram exemplifying an optimized CFG which is obtained in such a way that the process of code optimization illustrated in FIGS. 32 through 48 by using another example especially simplified is performed after the state assignment shown in FIG. 31;

FIG. 50 is an explanatory diagram showing a variable table after the optimization process as corresponds to FIG. 49;

FIG. 51 is an explanatory diagram exemplifying the algorithm of a “retain” analysis;

FIG. 52 is an explanatory diagram showing a variable table which corresponds to the result of the “retain” analysis;

FIG. 53 is an explanatory diagram showing a variable table in which the information items “retain” in FIG. 52 are overwritten by actual codes;

FIG. 54 is an explanatory diagram showing a state machine extraction process in a start state ST0;

FIG. 55 is an explanatory diagram showing a situation where codes conforming to “retain” information items are extracted from a variable table in correspondence with FIG. 54 and are utilized for the extraction of a state machine;

FIG. 56 is an explanatory diagram showing a state machine extraction process in a start state ST1;

FIG. 57 is an explanatory diagram showing a situation where codes conforming to “retain” information items are extracted from a variable table in correspondence with FIG. 56 and are utilized for the extraction of a state machine;

FIG. 58 is an explanatory diagram showing a state machine extraction process in a start state ST2;

FIG. 59 is an explanatory diagram showing a situation where codes conforming to “retain” information items are extracted from a variable table in correspondence with FIG. 58 and are utilized for the extraction of a state machine;

FIG. 60 is an explanatory diagram showing the first ones of HDL descriptions which have been generated by an HDL description generation process (S6);

FIG. 61 is an explanatory diagram showing ones of the HDL descriptions as succeed to the descriptions in FIG. 60; and

FIG. 62 is an explanatory diagram showing the last ones of the HDL descriptions as succeed to the descriptions in FIG. 61.

### DETAILED DESCRIPTION OF THE PREFERRED EMBODIMENTS

<<Outline of Design Method>>

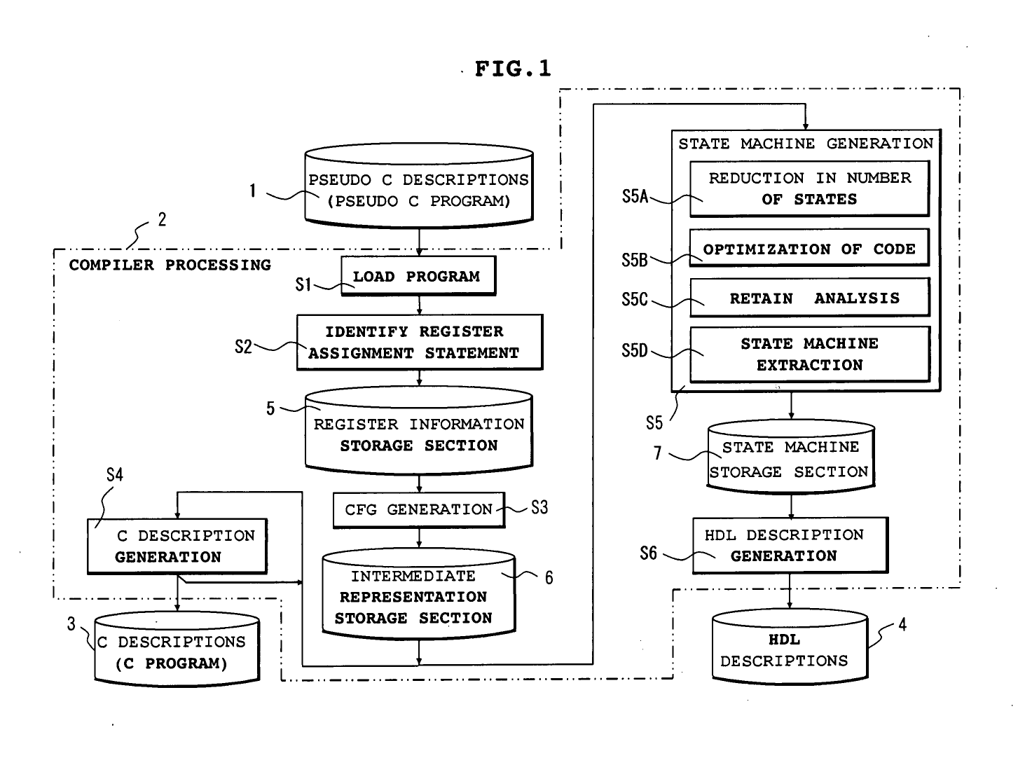

A logic circuit design method according to the present invention is exemplified in FIG. 1. The design method shown in the figure is broadly classified into the creation of pseudo C descriptions (pseudo C program) 1, and compiler processing 2 for the pseudo C program 1. In the compiler processing 2, the pseudo C program 1 is converted into a pseudo C program (stored in a storage section 5) whose transformed assignment statement is a register assignment description, and executable C descriptions (C program) 3. Besides, the C program 3 is converted into HDL (Hardware Description Language) descriptions 4 of RTL (Register Transfer Level) or the like.

The pseudo C program 1 is a program which includes a clock boundary description (also written “clock boundary” simply) capable of specifying a circuit operation at a cycle precision, and a register assignment statement, and which is capable of parallel descriptions at a statement level. The expression “pseudo C description” is used in the sense that it differs from a so-called “native” C language description in which the clock boundary and the register assignment statement are not defined. It shall not be excluded to base the program language on a high-class language other than the C language.

The compiler processing 2 is performed in such a way that a computer apparatus, not shown, executes a compiler and loads the pseudo C program 1. First, the pseudo C program 1 is loaded (S1). The register assignment statement is identified for the loaded pseudo C program 1, and the identified register assignment statement is transformed so as to be capable of referring to the state of a preceding cycle, in other words, it is transformed using an input variable and an output variable (S2). The transformed register assignment statement is also termed the “transformed assignment statement”. The pseudo C program in which the register assignment statement has been transformed into the transformed assignment statement, is stored in the register information storage section 5. This pseudo C program in which the register assignment statement has been transformed into the transformed assignment statement, is fetched from the register information storage section 5, and the control flow graph (hereinbelow, abbreviated to “CFG”) thereof is generated (S3). The generated CFG is stored in an intermediate representation storage section 6. The CFG stored in the intermediate representation storage section 6, and the pseudo C program stored in the register information storage section 5 are converted into the executable C description program (S4). By way of example, there is inserted a register assignment description insertion statement which adapts the variables of the transformed assignment statement to the change of a register attendant upon a cycle change, in correspondence with the clock boundary description. In other words, there is inserted a register assignment description insertion statement which assigns the output variable of the transformed assignment statement to the input variable thereof in correspondence with the clock boundary description.

In a case where the HDL descriptions 4 are obtained on the basis of the pseudo C program 5, etc., state machines are first generated by inputting them (S5). The state machine generation (S5) is broadly classified into a number-of-states reduction process (S5A), the optimization of a code (S5B), a “retain” analysis for conforming to the HDL descriptions (S5C), and state machine extraction (S5D). The number-of-states reduction process (S5A) and the optimization of the code (S5B) may well be grasped as processes which belong to the category of optimization processing. At the stage of the optimization of the code (S5B), whether or not a loop to be executed in the 0th cycle is existent is decided. If the loop is nonexistent, the “retain” analysis for conforming to the HDL descriptions (S5C), and the state machine extraction (S5D) are performed. In obtaining the C description program, the register assignment description insertion statement may be inserted into, for example, a clock boundary node. In obtaining the HDL description, however, even in a case where a register value does not change at the clock boundary, this fact needs to be explicitly described. Therefore, the “retain” analysis (S5C) is made. The state machine to be generated is generated on the basis of a conversion table of every state transition. The generated state machine is held in a state machine storage section 7. The HDL descriptions 4 are generated on the basis of such state machines held (S6).

The HDL description 4 are made convertible into logic circuit diagram data by utilizing a logic synthesis tool. The C descriptions 3 are utilized for the simulation of a logic circuit which is to be logically synthesized, and so forth.

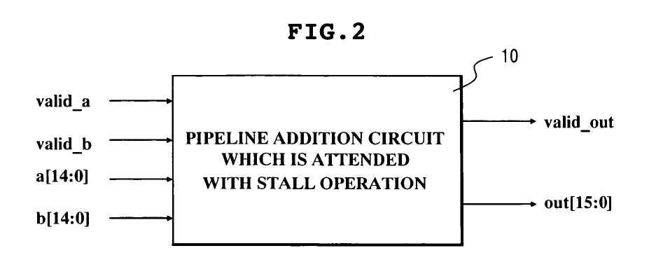

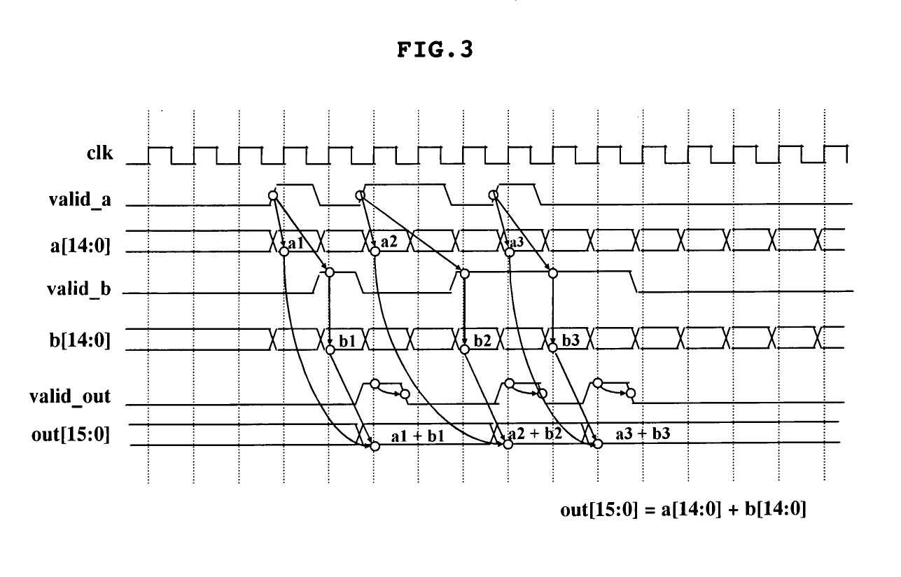

Now, the pseudo C program and the compiler processing thereof will be described in detail. The ensuing detailed description will exemplify a circuit design in which specifications in FIG. 3 are fulfilled in a circuit in FIG. 2.

<<Circuit to be Designed>>

Shown in FIG. 2 is a circuit example which is to be designed by applying the design method in FIG. 1. A circuit to-be-designed 10 is a pipeline addition circuit which is attended with a stall operation. The operating specifications of the circuit are as follows:

(1) When an input signal valid_a rises, the value of an input signal “a” in a cycle whose signal level has become a high level is accepted. Here, the rise change of the signal valid_a becomes an issue.

(2) When the signal level of an input signal valid_b becomes the high level in a cycle next to the rise of the input signal valid_a or in a still later cycle, the value of an input signal “b” in the cycle is accepted. As to the input signal valid_b, only level detection suffices, and the detection of an edge change is unnecessary.

(3) When the signals “a” and “b” have been accepted by the operations (1) and (2), the added result of the signals “a” and “b” is delivered as an output signal “out” in the next cycle, the signal level of an output signal valid_out is brought to the high level in the same cycle, and the signal level of the output signal valid_out is brought to a low level in the next cycle.

(4) Unless a new added result is assigned by the operations (1), (2) and (3), the output signal “out” assumes the same value.

(5) The output signal valid_out has its signal level rendered high only in the cycle in which the new added result has been assigned to the output signal “out” by the operations (1), (2) and (3), and it assumes the low level else.

FIG. 3 is a timing chart showing the operating specifications of the circuit in FIG. 2. Referring to FIG. 3, the output data delivery and the input data acceptance proceed in the identical cycle, so that a pipeline operation is executed. By way of example, the input of data a2 and the output of data a1+b1 are parallelized. Besides, the output data is delivered in a cycle next to the cycle in which the value of the input signal valid_b has become “1”, in or after the cycle next to the rise of the input signal valid_a, so that the pipeline operation is attended with the stall operation. By way of example, the acceptance of data b2 waits for 2 cycles after the acceptance of data b1.

<<Pseudo C Program>>

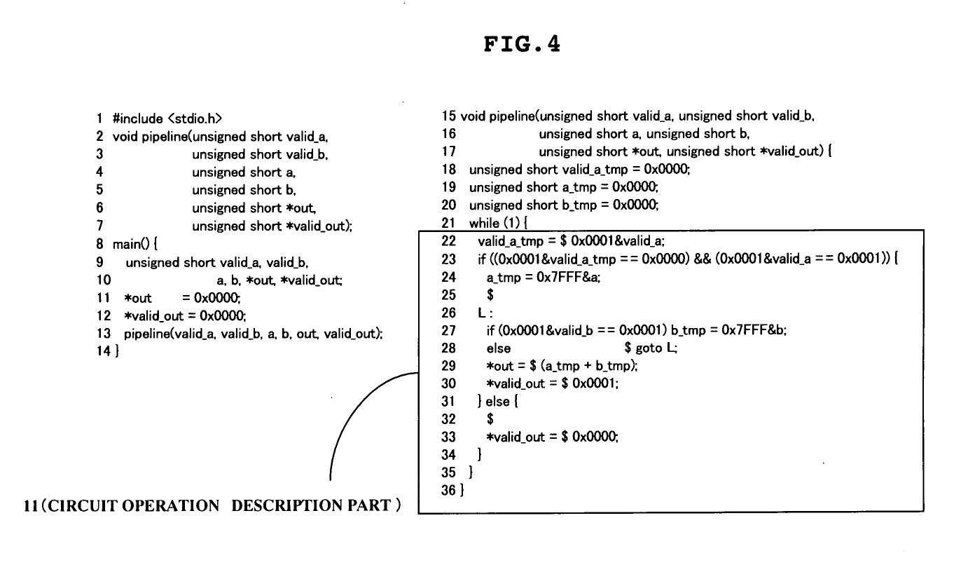

Exemplified in FIG. 4 is the pseudo C program of the circuit to-be-designed 10. In the descriptions in FIG. 4, numeral 11 indicates a circuit operation description part in which the circuit operation of the circuit to-be-designed 10 is described. The descriptions of the pseudo C program shown in the figure are as follows:
Line 1: Library invocation in C language
Lines 2-7: Prototype declaration part of Function pipeline
Lines 8-14: Main function part
Lines 9-10: Local variable declaration part of Main function, in which Output signal is declared in Pointer type
Lines 11-12: Initialization of Local variable of Main function (Only an output signal is initialized, and especially in a case where a register is presumed at conversion into an RTL as to the output signal, an initial value designated here becomes a reset value.)
Lines 15-36: Pipeline function part
Lines 18-20: Local variable declaration part of Pipeline function (Especially in a case where the register is presumed at the conversion into the RTL as to a local variable, an initial value designated here becomes a reset value)
Lines 21-35: Circuit operation description part 11

The details of the circuit operation description part 11 are as follows:
Lines 21 and 35: Representation of Circuit by Endless loop
Line 22: Statement of Register assignment of Input variable valid_a to Local variable valid_a_tmp (Here, it is designated by 0x0001&valid_a that the effective bit width of the input variable valid_a is one bit.)
Line 23: Decision statement as to Whether or Not Input variable valid_a is 1′b1 and Local variable valid_a_tmp is 1′b0 (That is, a decision statement as to whether or not the input variable valid_a rises. Especially, it is designated by 0x0001&valid_a_tmp that the effective bit width of the local variable valid_a_tmp is one bit.)
Line 24: Statement of Assignment of Input signal “a” to Local variable a_tmp (Especially, it is designated by 0x7FFF&a that the effective bit width of the input variable “a” is 15 bits.)
Line 25: Clock boundary
Line 26: Goto label
Lines 27-28: It is expressed that, if the input variable valid_b is 1′b1, the input variable “b” is assigned to a local variable b_tmp, and that a branch is caused to a label L astride one clock boundary else. (Especially, it is expressed by 0x0001&valid_b that the effective bit width of the input variable “b” is one bit, and by 0x7FFF&b that the effective bit width of the input variable “b” is 15 bits.)
Line 29: Statement of Register assignment of Sum between Local variables a_tmp and b_tmp, to Output variable “out”
Line 30: Statement of Register assignment of Constant 0x0001 to Output variable valid_out
Line 31: Expressing Branch in case where Decision of if Statement at Line 23 has Failed, that is, Branch in case where Input variable valid_a has not Risen
Line 32: Clock boundary
Line 33: Statement of Register assignment of Constant 0x0000 to Output signal valid_out

Symbol “$” signifies the clock boundary description, and symbol “=$” the register assignment. They are not the general descriptors or operators of the C language. The pseudo C program employing them can be called “program descriptions diverting the C language” in that sense.

As understood from the circuit operation description part 11, the parallel operation can be simply described at a statement level and at a cycle precision by the clock boundary descriptions and the register assignment statements. The “cycle precision” signifies that synchronism with clock cycles is intended.

There will be explained the descriptive contents of the circuit operation description part 11 in FIG. 4. The input variable valid_a is assigned to the local variable valid_a_tmp, thereby to decide the rise of the input variable valid_a based on the if statement. In the case of the rise, the input signal “a” is accepted into the local variable a_tmp, and whether or not the input signal valid_b is 1′b1 is decided in the next cycle. If the input signal valid_b is 1′b1, the value of the input signal “b” is assigned to the local variable b_tmp, and if not, whether or not the input signal valid_b is 1′b1 is decided again in the next cycle. This is iterated until the input signal valid_b becomes 1′b1. This operation corresponds to the stall operation. Here, the sum between the local variables a_tmp and b_tmp expresses the sum between the accepted values “a” and “b”, and it is register-assigned to the output variable “out”, while at the same time, 1′b1 is register-assigned to the output signal valid_out. Thus, it is represented that the addition result and the valid_out signal are 1′b1 one cycle after the acceptance of the input signals “a” and “b”. In the case where the input signal valid_a has not risen as the result of the rise decision thereof based on the if statement, 1′b0 is register-assigned to the signal valid_out one cycle later. The rise of the signal valid_a can occur, at most, only once in two cycles. Therefore, the signal valid_out becomes 1′b1 only when the new assignment to the variable “out” has been done at Line 29, and it becomes 1′b0 else.

The register assignment statement at Line 22 in FIG. 4 supposes a register being a sequential circuit, in order to specify the operation at the cycle precision, and the left hand (valid_a_tmp) thereof can be grasped as a variable which holds the output of the register, namely, the value of the last cycle. The right hand (0x0001&valid_a) of the register assignment statement can be grasped as the register input at the current time. Besides, regarding the register assignment statements contained at Lines 29 and 30 in FIG. 4, a clock is consumed in the clock boundary description at Line 32 later. Herein, the signal “out” is output in the next cycle in accordance with the circuit specifications in FIGS. 2 and 3. As a result, descriptions at the cycle precision are infallibly required as to the signals “out” and valid_out, and register assignment statements are therefore employed for the descriptions.

<<Identification of Register Assignment Statement>>

Next, the register assignment statement identifying process S2 will be described. In the register assignment statement identifying process part, an assignment statement in which the symbol $ is added between symbol=and the right hand is identified, the register assignment statement in the circuit operation description part 11 and the type and initial value of the variable at the left hand of the register assignment statement are stored, and the identified register assignment statement:
signal_latched=$ signal
   is altered to descriptions:
signal_latched_i=signal;
signal_latched=signal_latched_o.

It is possible to grasp signal_latched_i as an input variable as which an input at the current time is given, and signal_latched_o as an output variable as which an output in the last cycle is assigned. The new variables having developed by the alteration:
signal_latched_i, signal_latched_o
   are added to the variable declaration part by referring to the type and initial value of the variable stored before. In case of, for example:
unsigned char signal_latched=0x01,
   there are added:
unsigned char signal_latched o=0x01;
unsigned char signal_latched_i.

Especially in a case where the variable at the left hand of the register assignment is of the pointer type (to which symbol * is affixed), a variable declaration is done using the pointer type. In case of, for example:
unsigned char *signal_latched,
   there are added:
unsigned char signal_latched_o=0x01;
unsigned char signal_latched_i.

Especially for the variable to-be-added, a flag variable which is of the same type and whose initial value is “0” is also stored as such. In case of this example:
unsigned char flg_signal_latched=0x00
   is stored as the variable to-be-added. Incidentally, the descriptions having undergone the above alterations are also stored. Besides, the initial value of the variable is employed as a reset value in a case where the register presumption for the variable has been done at the HDL conversion.

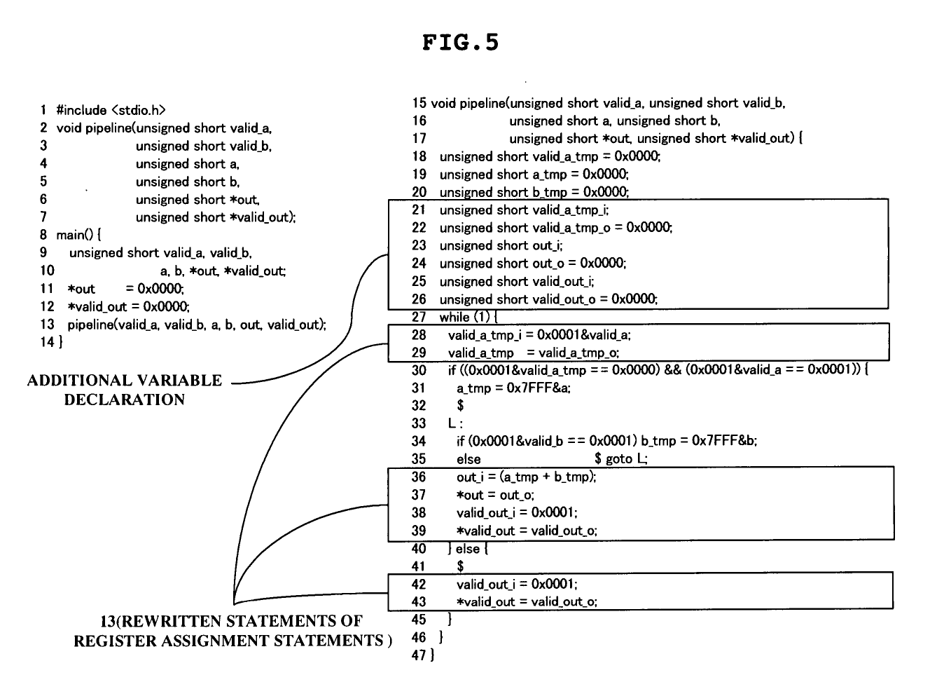

Exemplified in FIG. 5 are the results obtained by the register assignment statement identifying process S2. The descriptions of an additional variable declaration and the descriptions of transformed assignment statements (rewritten register assignment statements) 13 have been altered as compared with the descriptions of the pseudo C program in FIG. 4.

<<CFG Generation>>

Next, the CFG generation process will be explained. The “CFG” generally signifies a graph which indicates the flow of a control within each function.

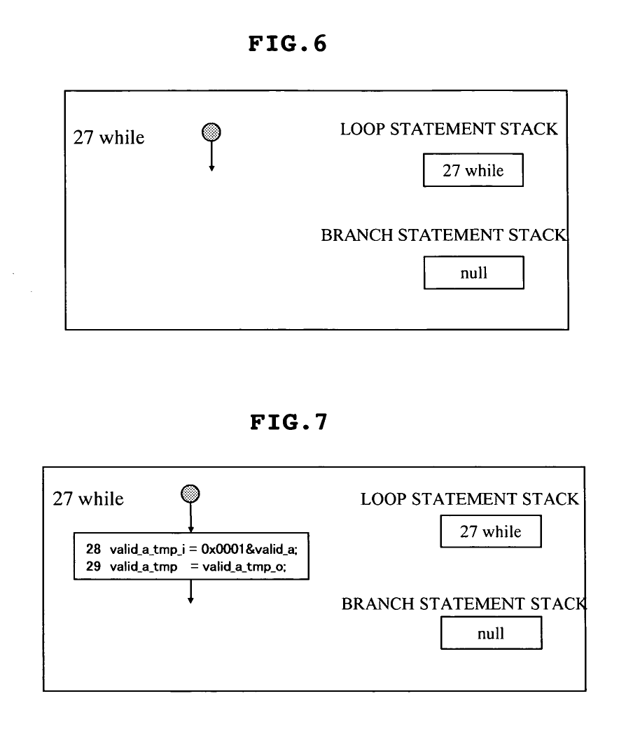

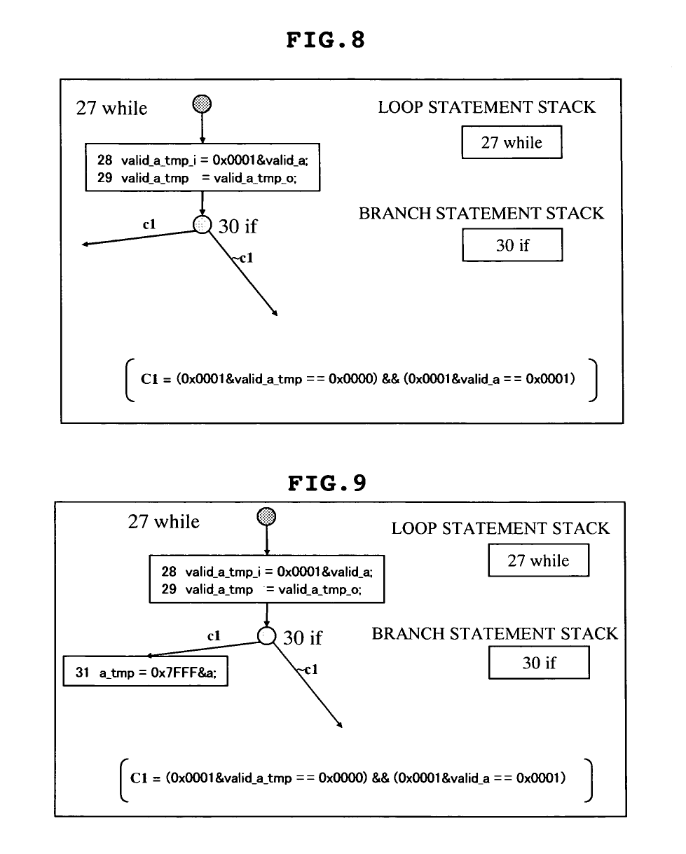

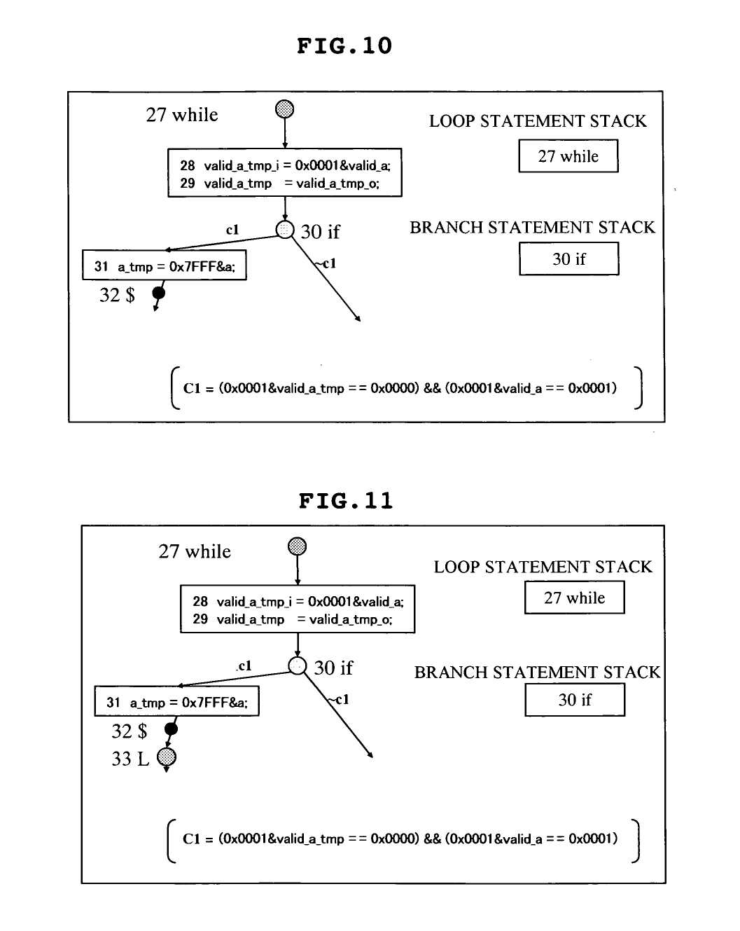

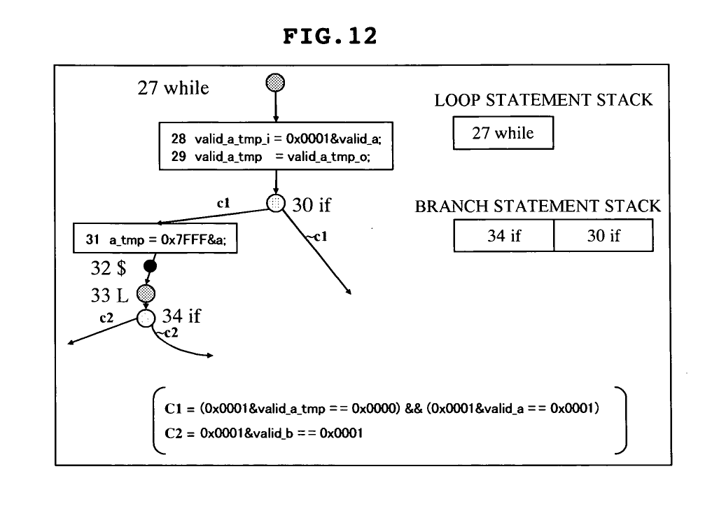

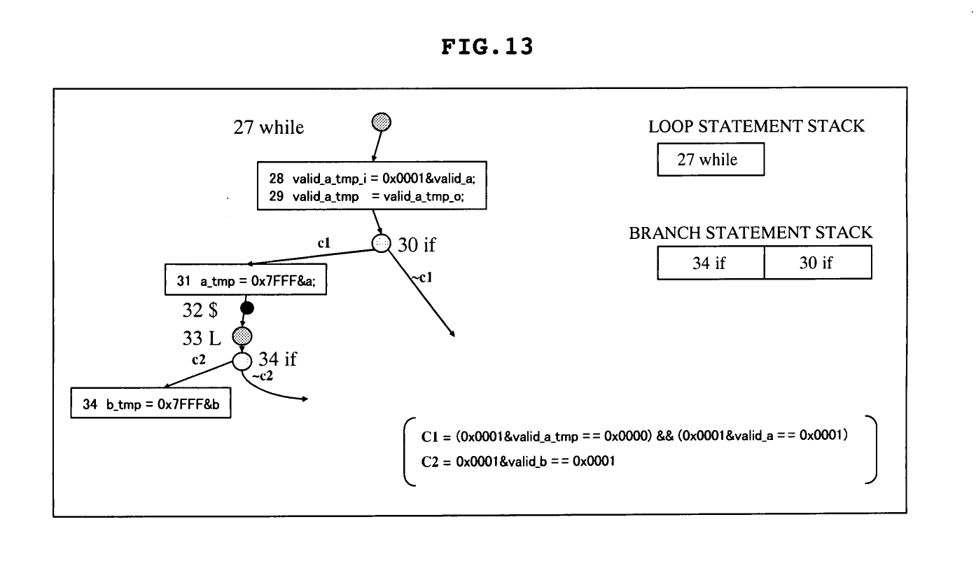

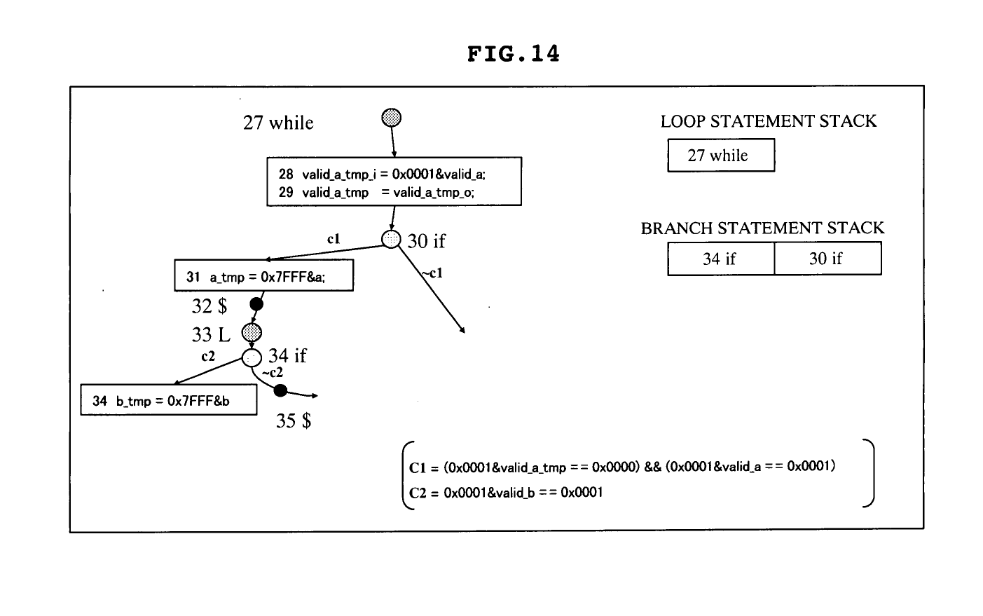

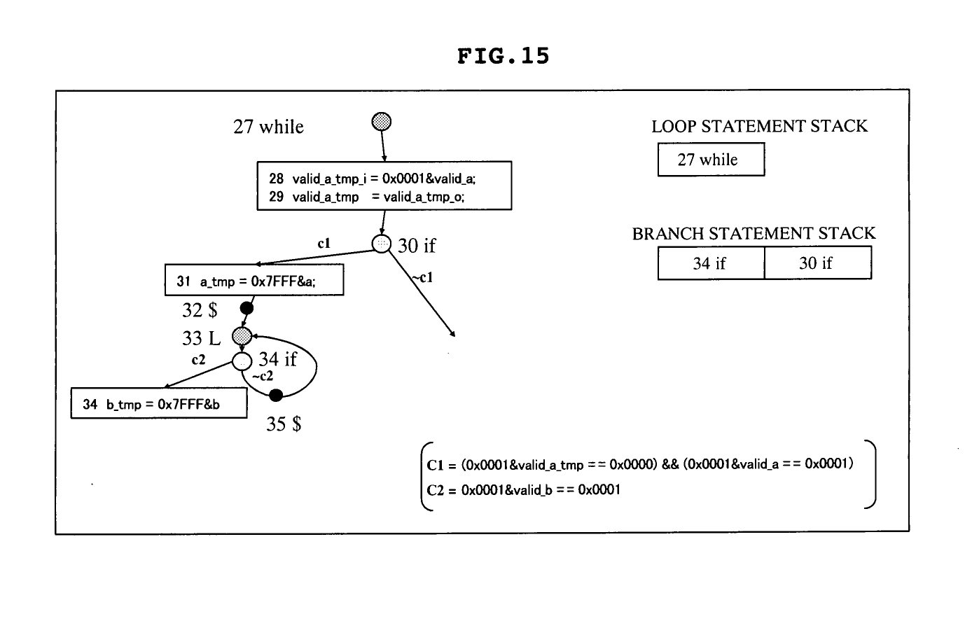

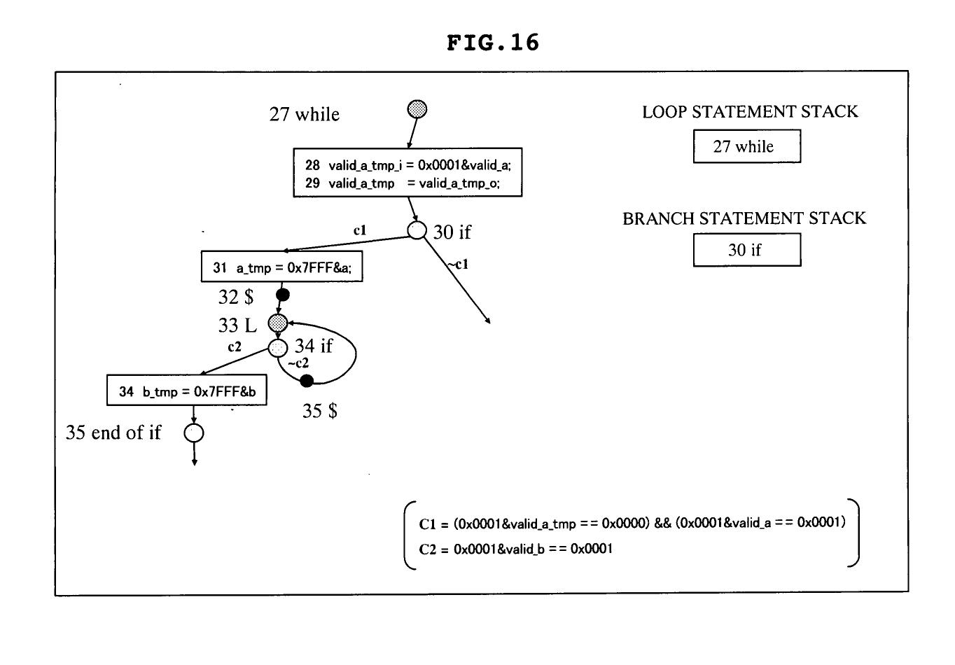

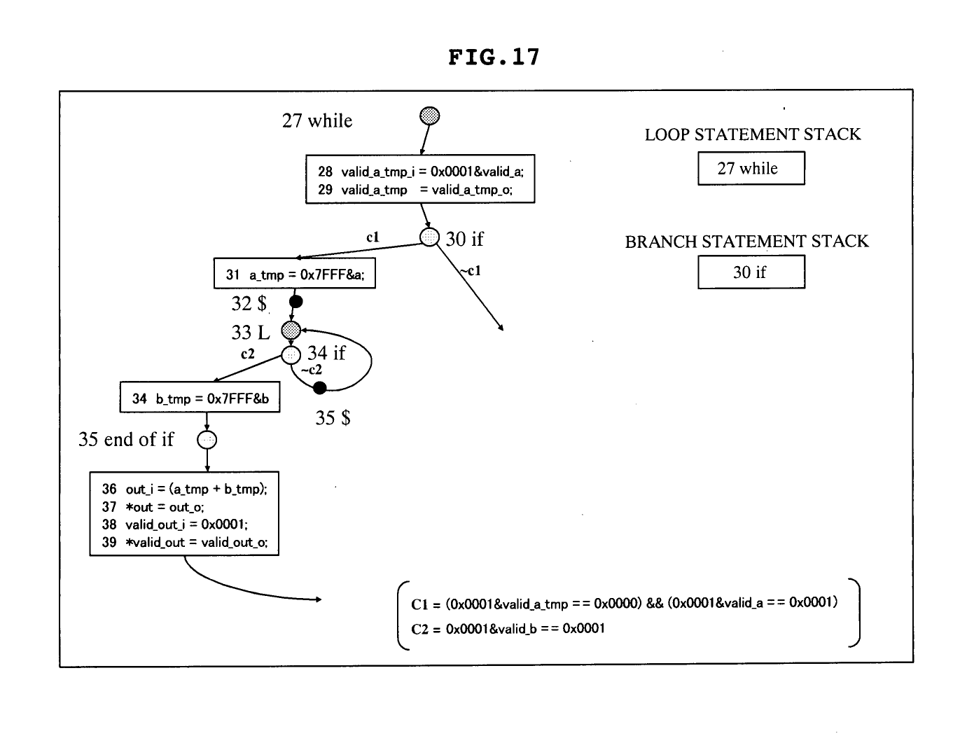

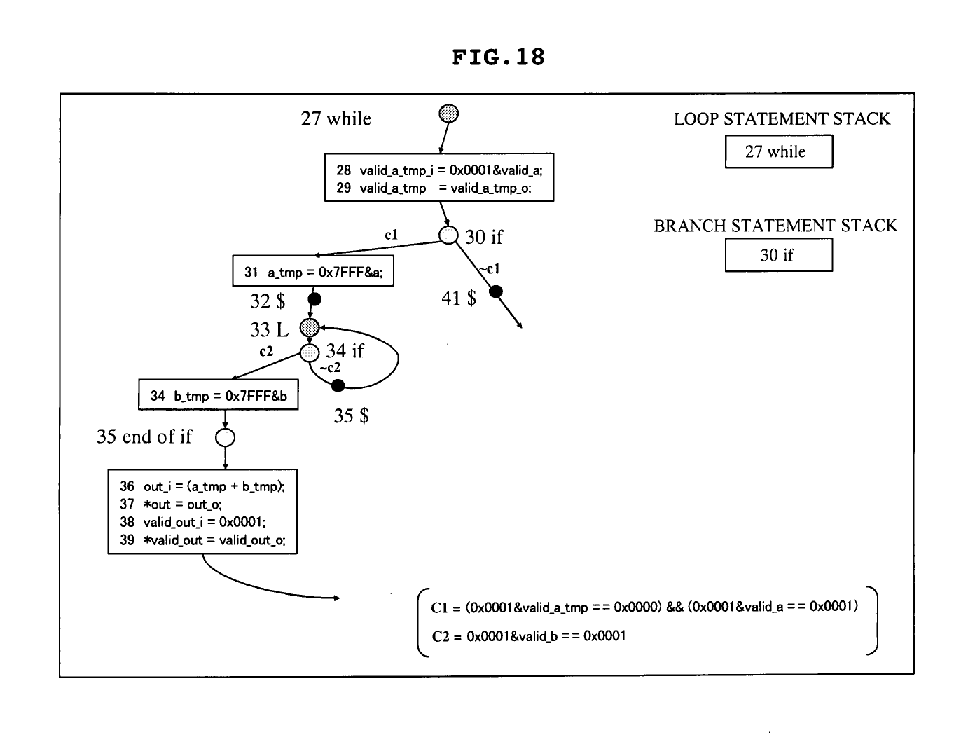

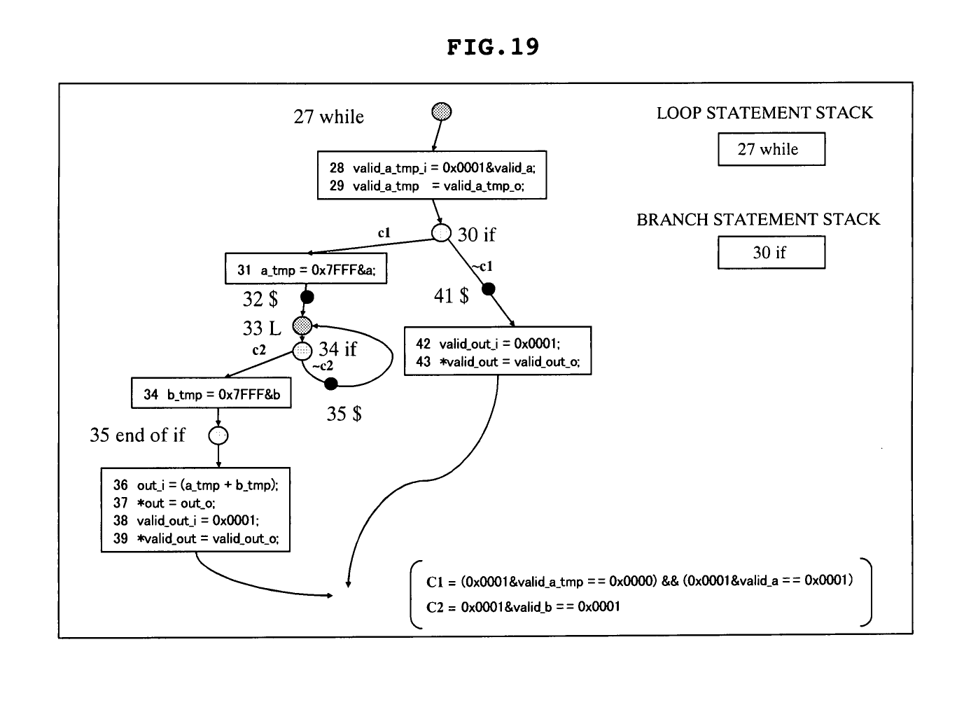

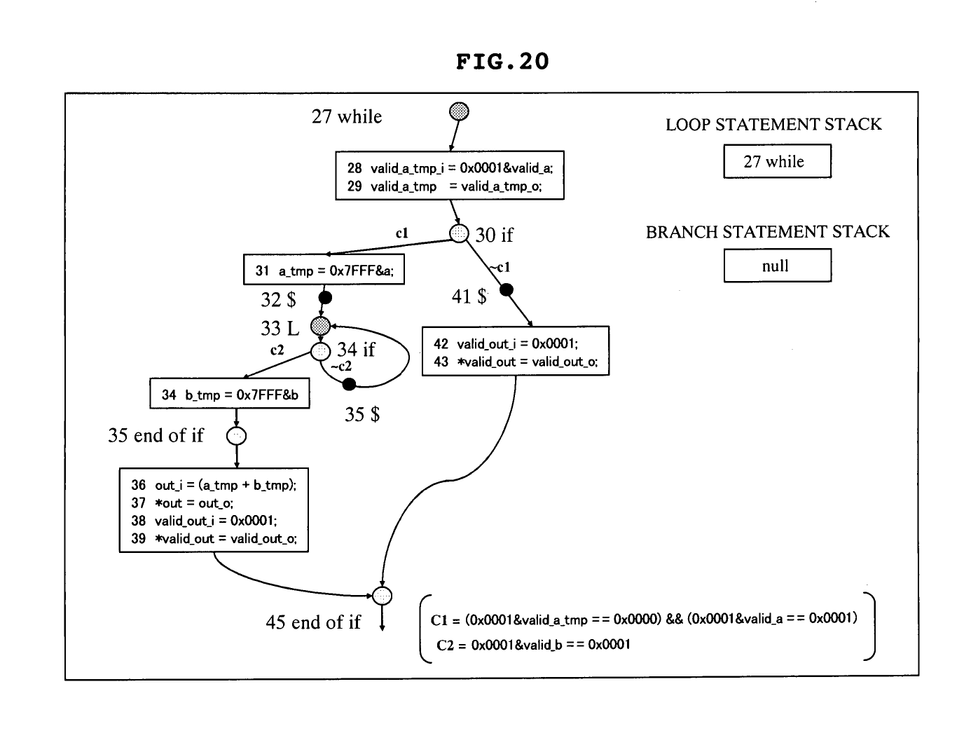

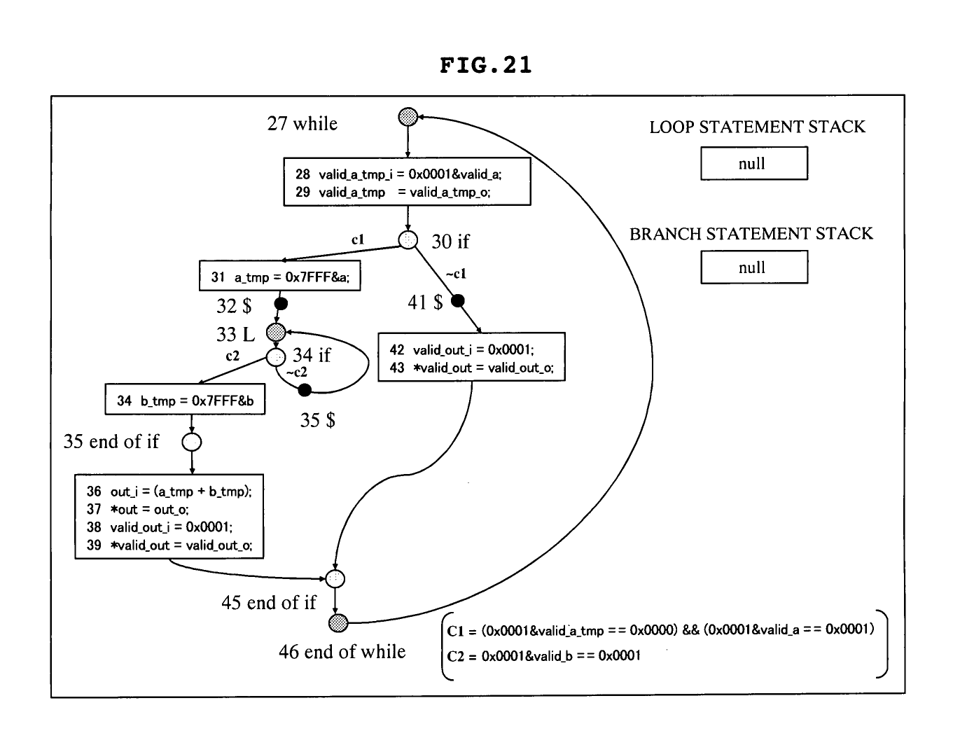

In the CFG generation process, the CFG is created by loading the circuit operation description part 11. In particular, the process creates the CFG which has nodes for identifying the loops of “while”, “for”, etc., the conditional branches of “if”, “case”, etc., and label branches to labels based on goto statements. After all, the process creates the CFG which has as its nodes, the loops of “while”, “for”, etc., the conditional branches of “if”, “case”, etc., and the label branches to the labels based on the goto statements. The CFG is created in such a way that individual statements are loaded till the end of the program, and that the nodes are connected by directed sides (sides having directions) along the flow of the program while the nodes are being created in accordance with a procedure of steps 1)-7) stated below. A creation process for the CFG as conforms to the procedure of steps 1)-7) is shown in due course in FIGS. 6 through 21. A loop statement stack, a branch statement stack, and the CFG in the course of the generation are shown in each of the figures.

1) At the start of a loop, the line No. of the loop and a terminal symbol expressive of the loop, such as “while” or “for”, are registered in the loop statement stack, a loop start node (NDs) is created, and the line No. and the terminal symbol are affixed to the node. Besides, in the presence of a “for” or “while” loop end condition, the condition is assigned to a suitable symbol and is affixed to an output branch, and the affixed condition is stored in a pair with the allotted symbol.

2) At the end of a loop, information lying at the head is taken away from the loop statement stack, a loop end node expressive of the loop end is created, and the line No. and “end of the terminal symbol” of the loop are affixed to the node. However, “continue” or “break” is not handled as the end of the loop. Besides, in the presence of a “do-while” loop end condition, the condition is assigned to a suitable symbol and is affixed to an output branch, and the affixed condition is stored in a pair with the allotted symbol.

3) At the start of a conditional branch, the line No. of the branch and a terminal symbol expressive of the branch, such as “if” or “case”, are registered in the branch statement stack, a conditional branch start node is created, and the line No. and the terminal symbol are affixed to the node. Besides, a branch condition is assigned to a suitable symbol and is affixed to an output branch, and the affixed condition is stored in a pair with the allotted symbol.

4) At the end of a conditional branch, information lying at the head is taken away from the branch statement stack, a conditional branch end node expressive of the conditional branch end is created, and the line No. and “end of the terminal symbol” of the branch are affixed to the node.

5) In case of a label, a label node expressive of the label is created, and the line No. and label symbol of the label are affixed to the node.

6) In case of a clock boundary, a clock boundary node is created, and the line No. and symbol $ of the clock boundary are affixed to the node.

7) In any case other than the above, a node to which the corresponding line No. and statement are affixed is created, and the node is merged until any of the cases 1)-6) is met.

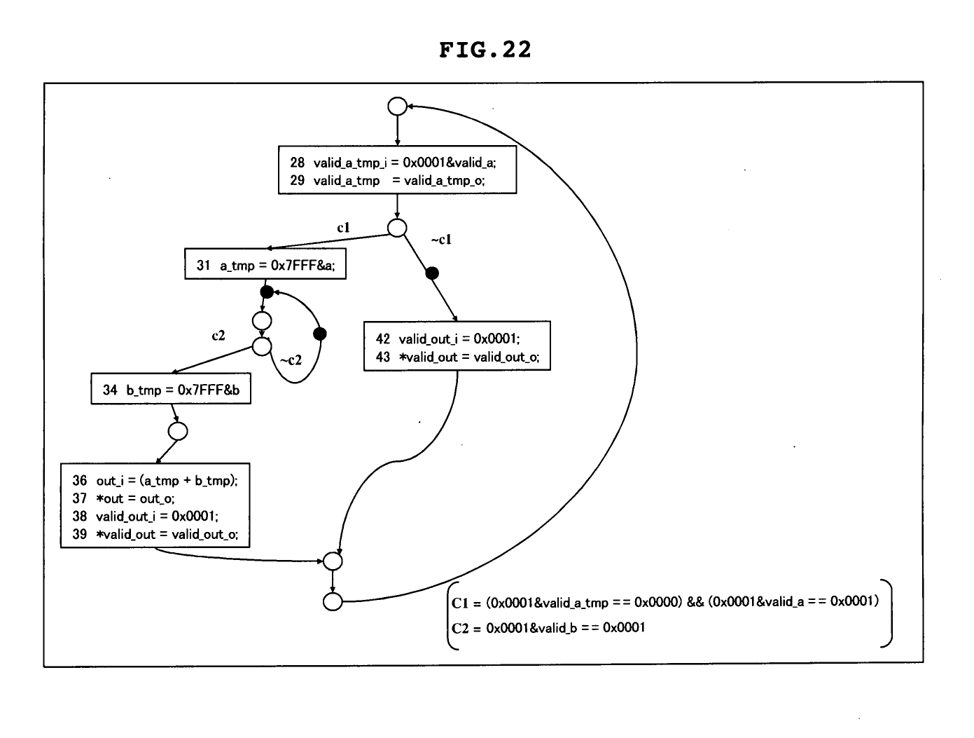

The CFG is created in accordance with the above procedure of steps. In the ensuing description, however, the CFG in which information items on the clock boundary, the start point/end point of the branch, and the start point/end point of the loop are not affixed as exemplified in FIG. 22 shall be used for the brevity of the description. Especially, only the clock boundary node is represented by a black round mark, and the other loop, conditional branch and label branch nodes are represented by white round marks.

<<C Description Generation>>

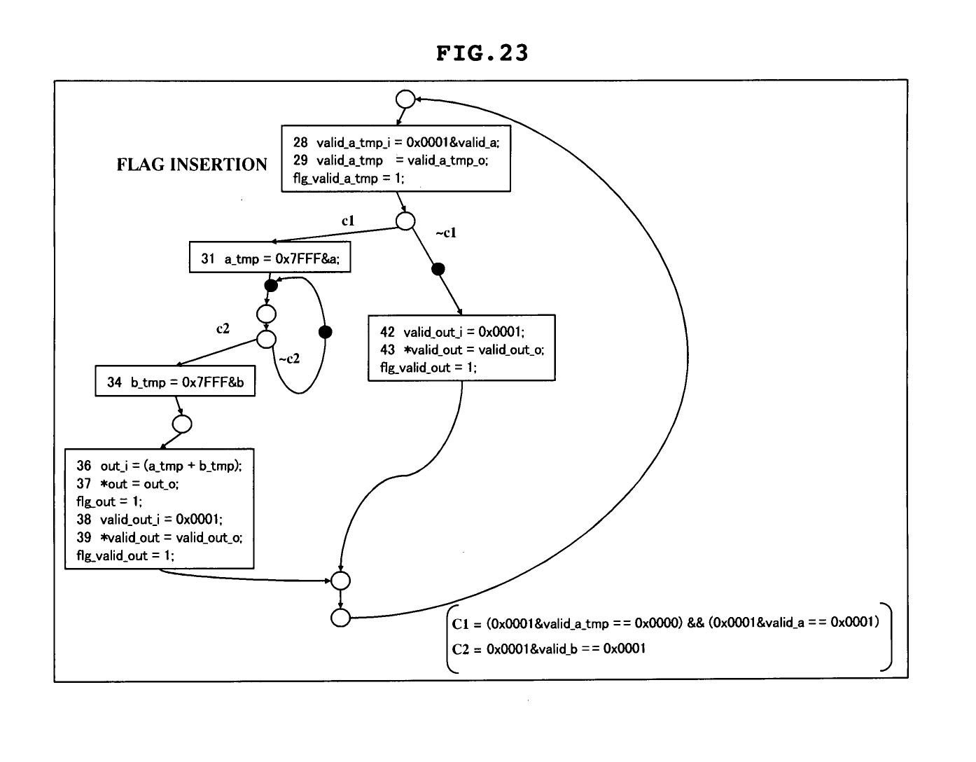

The C description generation process S4 will be explained. In the C description generation process S4, there are inserted a statement which assigns “1” to a flag variable among the variables stored as the variables to-be-added in the register assignment statement identifying process, the flag variable lying directly under the part (transformed assignment statement) altered in the register assignment statement identifying process, and a statement which assigns “0” to a flag variable lying directly under an assignment statement that is not a register assignment statement and that is for the variable of the left hand of the register assignment statement. Simultaneously therewith, the variable declaration stored in the register assignment statement identifying part is added to the local variable declaration part. In FIG. 23, the flags of flg_valid_a_tmp=1 and flg_valid_out=1 are inserted.

Subsequently, register assignment description insertion statements are determined. Herein, the register assignment description insertion statements are created for all the variables of the right hand of the register assignment statement identified in the register assignment statement identifying process S2. More specifically, subject to:
register assignment statement:
signal_latched=$ signal;
altered descriptions:
signal_latched_i=signal;
signal_latched=signal_latched_o;
   added variables:
signal_latched_i, signal_latched_o, flg_signal_latched,
the following descriptions are created:
signal_latched_o=signal_latched_i;
if(flg_signal_latched==1) signal_latched=signal_latched_o.

The descriptions are created for all the variables of the right hand of the register assignment statement identified in the register assignment statement identifying process. In the case of the example, the following descriptions are obtained:
valid_a_tmp_o=valid_a_tmp_i;
if(flg_valid_a_tmp==1) valid_a_tmp=valid_a_tmp_o;
out_o=out_i;
if(flg_out==1)*out=out_o;
valid_out_o=valid_out_i;
if(flg_valid_out==1)*valid_out=valid_out_o.

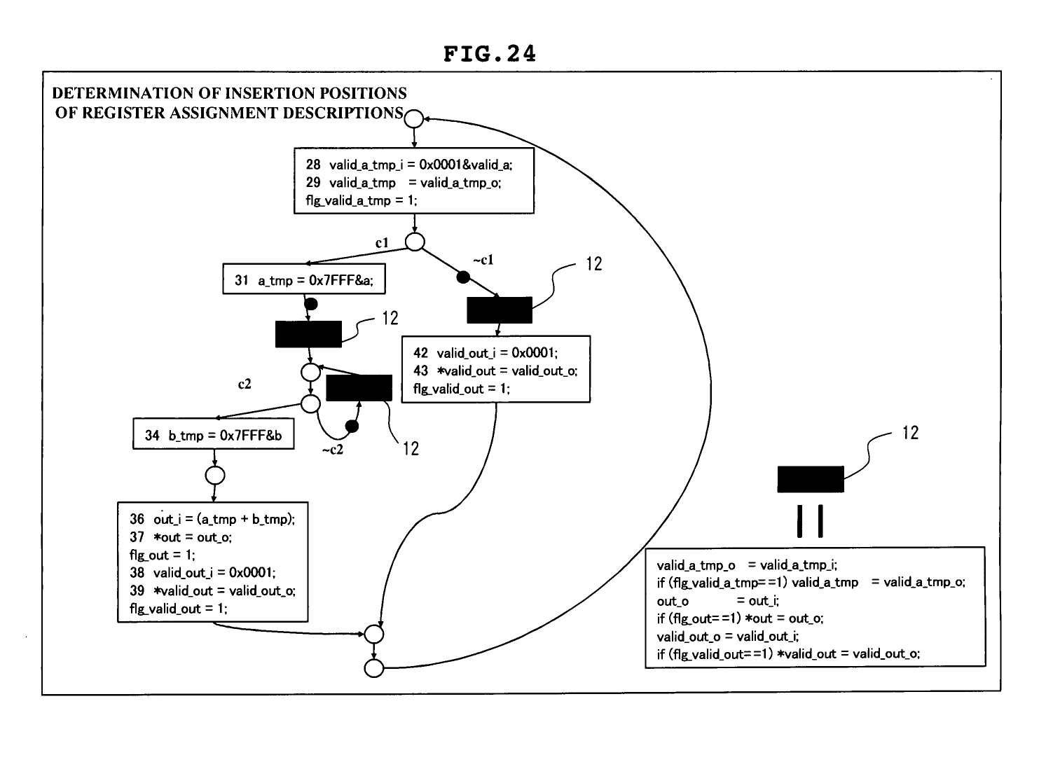

As exemplified in FIG. 24, the register assignment description insertion statements are inserted directly under the clock boundary nodes. In FIG. 24, reference numerals 12 are given to the register assignment description insertion statements. The conversions into the C descriptions thus proceeding may be performed in consideration of the order of the insertion statements in such a way that the CFG is searched by executing an algorithm such as depth-first search (DFS) on the basis of the information items of the line Nos. affixed to the individual nodes, etc. Incidentally, comment statements may well be appropriately inserted.

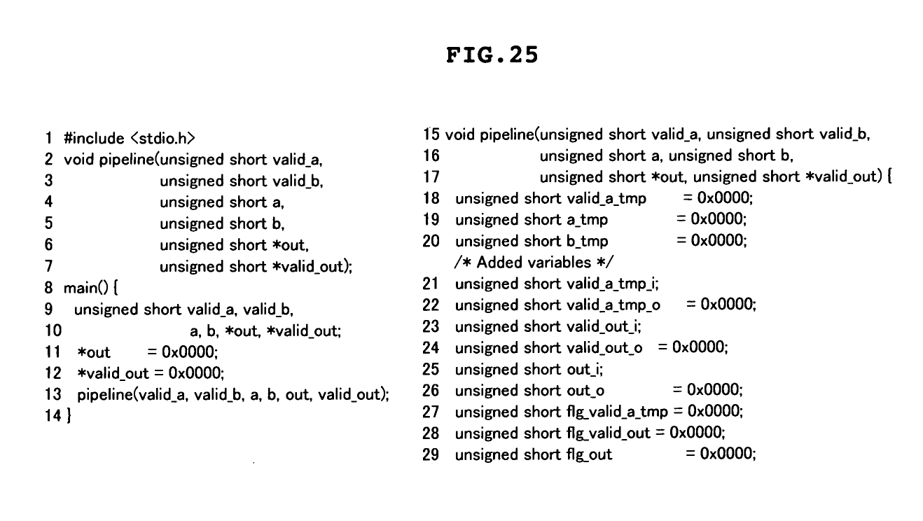

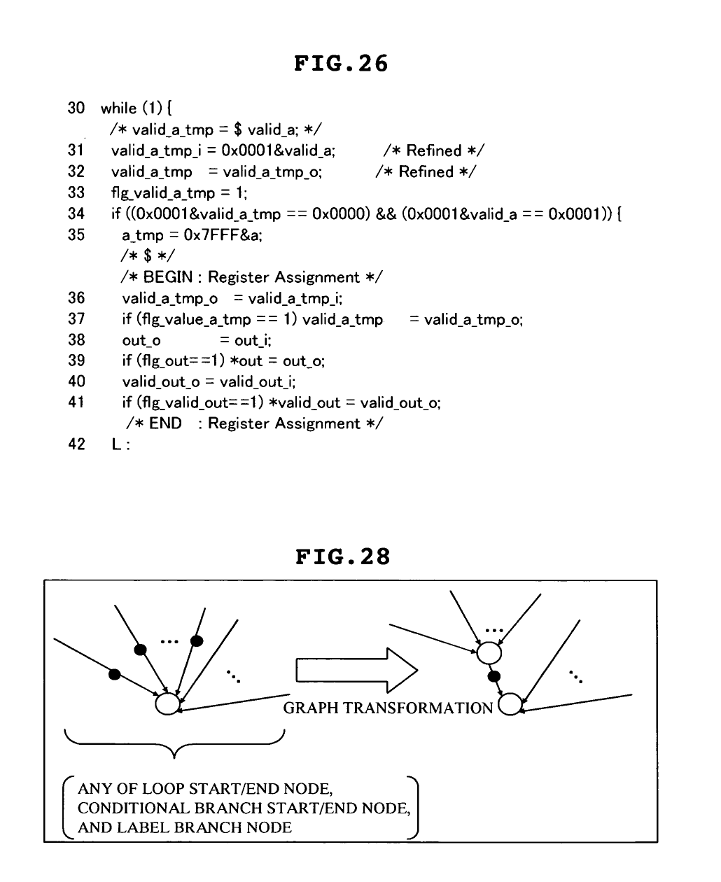

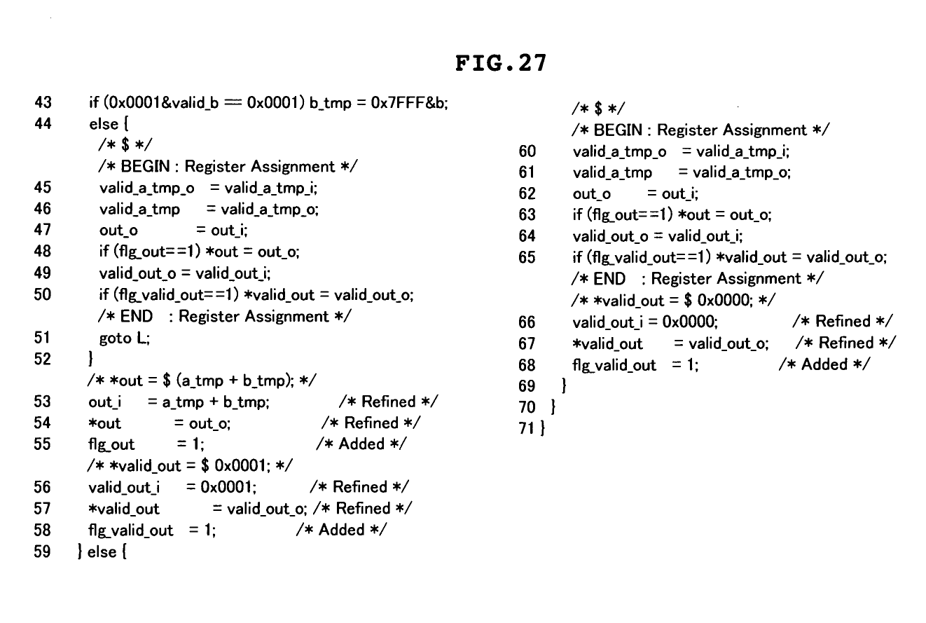

Exemplified in FIGS. 25 through 27 is the entirety of the executable converted C descriptions (C program) 3 which have been obtained via the C description generation process s4.

<<State Machine Generation—Number-of-States Reduction>>

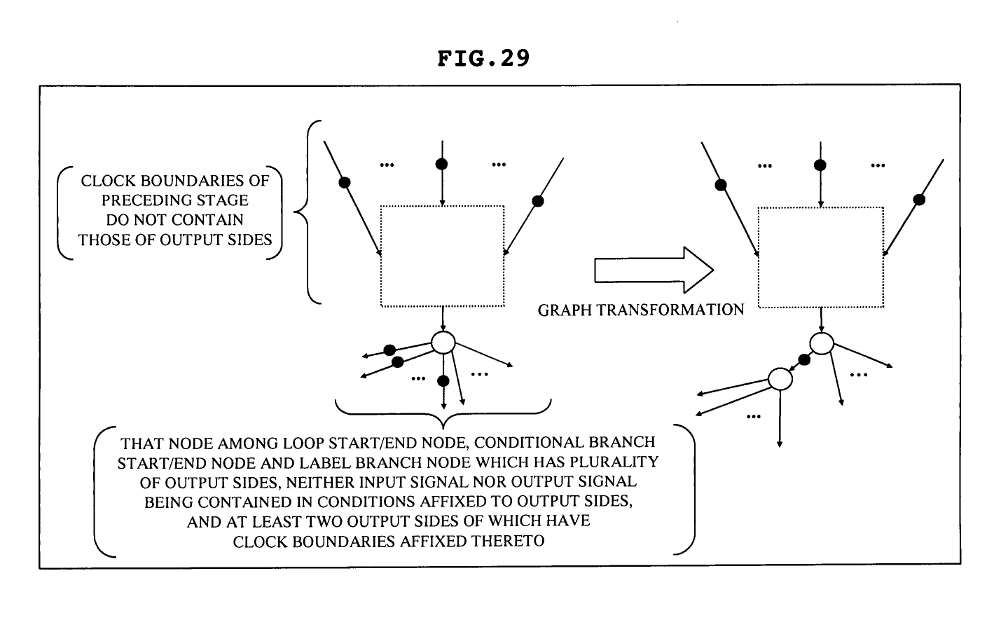

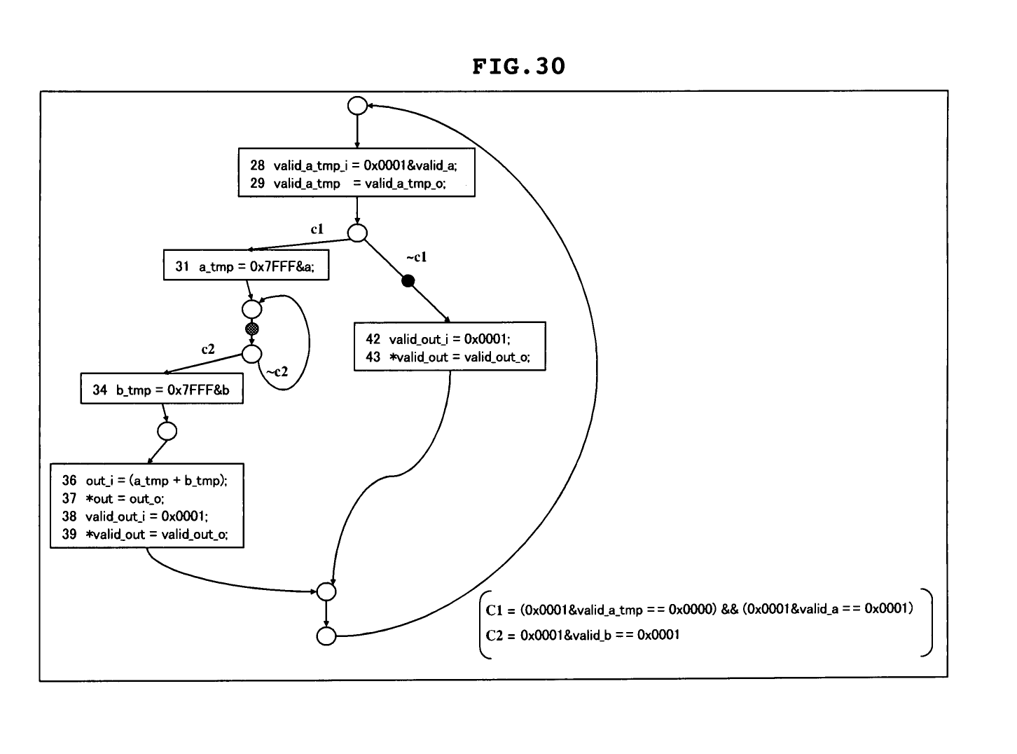

The state machine generation process S5 will be described. The number-of-states reduction process S5A is performed in conformity with, for example, a first or second rule. The first rule of the number-of-states reduction process is exemplified in FIG. 28. More specifically, there is searched for any of the loop start/end node, conditional branch start/end node and label branch node as has a plurality of input sides, and a graph transformation shown in the figure is performed in a case where at least two of the input sides have clock boundaries. The second rule of the number-of-states reduction process is exemplified in FIG. 29. More specifically, there is searched for that node among the loop start/end node, conditional branch start/end node and label branch node which has a plurality of output sides, neither an input signal nor an output signal being contained in conditions affixed to the output sides, and at least two output sides of which have clock boundaries affixed thereto, and a graph transformation shown in the figure is performed in a case where the clock boundaries of the preceding stage of the node do not contain the clock boundaries of the output sides. Exemplified in FIG. 30 are results which have been obtained by subjecting the CFG in FIG. 22 to the reduction of the number of states.

<<State Machine Generation—Code Optimization>>

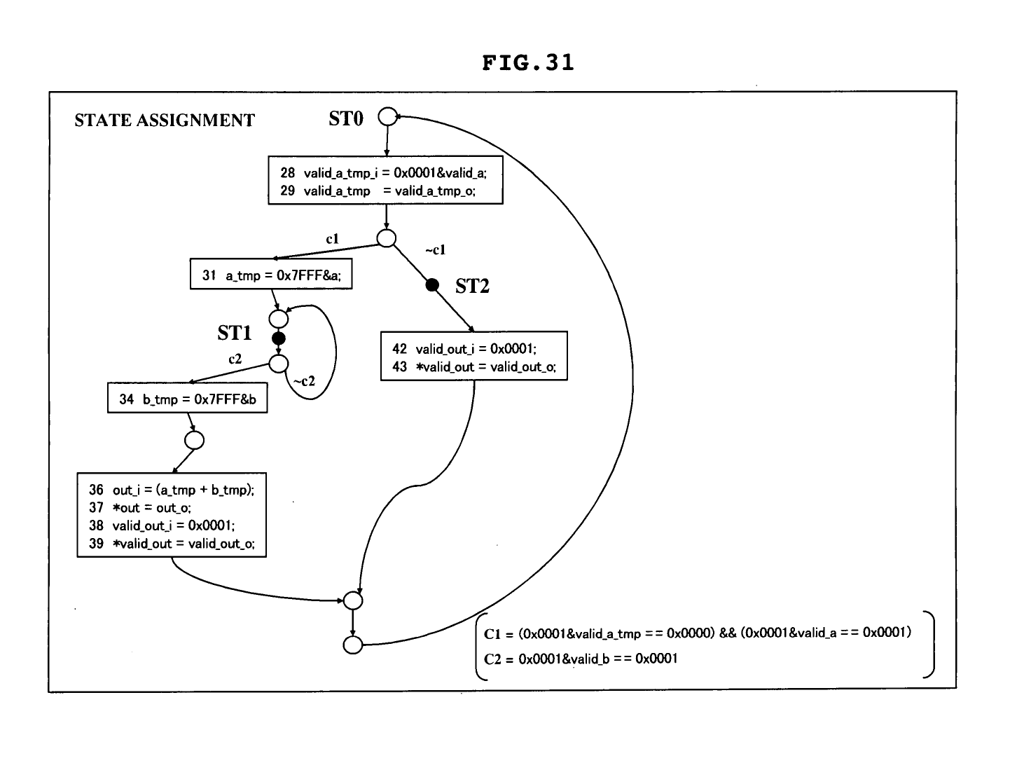

In the code optimization process S5B, as exemplified in FIG. 31, states are assigned to the CFG subjected to the processes of the number-of-states reduction, etc. According to FIG. 31, an initial state is assigned to a node on the CFG as corresponds to the start statement of the circuit operation part, and a state is assigned to a clock boundary node on the CFG. However, in a case where only one input side to the start node exists and where a clock boundary is affixed thereto, the initial state already assigned is deleted. Incidentally, it should desirably be noted that a necessary and sufficient condition for the occurrence of the initial-state deletion as conforms to the first rule of the optimization is the existence of only one input side to the start node and the affixation of the clock boundary thereto. It should also be noted that the number of obtained states infallibly becomes, at most, (the number of clock boundaries described in the circuit operation part+1).

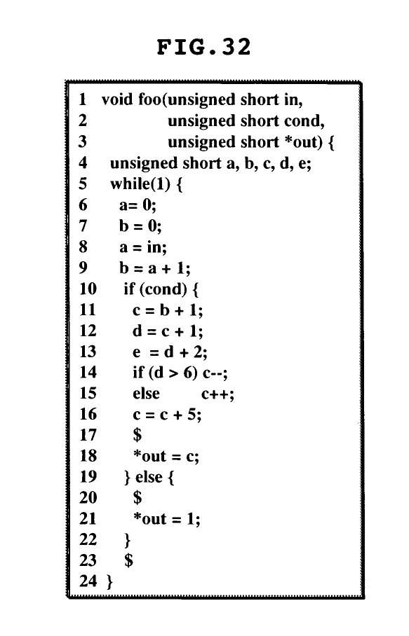

Here, the process of the code optimization will be described using another example especially simplified, with reference to FIGS. 32 through 48.

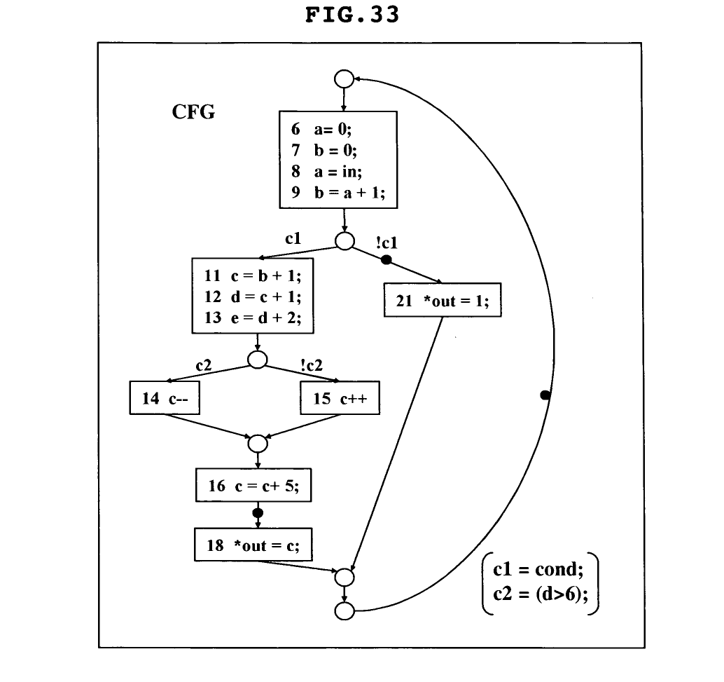

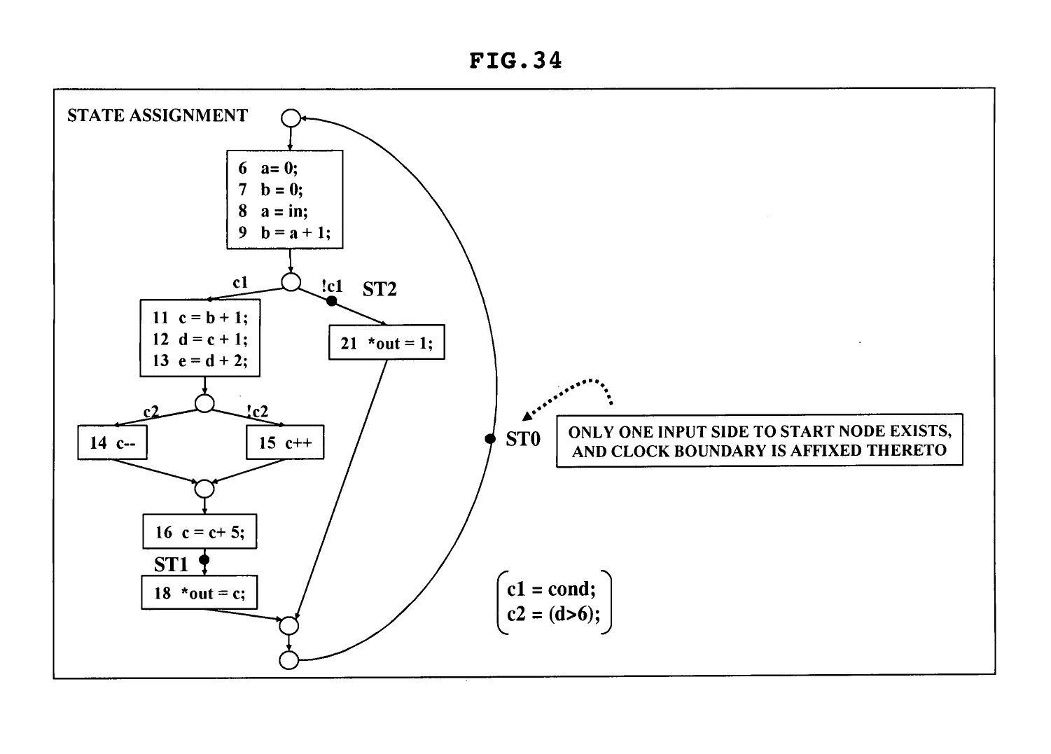

FIG. 32 shows the pseudo C program which is a subject for the code optimization. A CFG obtained on the basis of the pseudo C program is exemplified in FIG. 33. Exemplified in FIG. 34 is a situation where states are assigned to the CFG in FIG. 33.

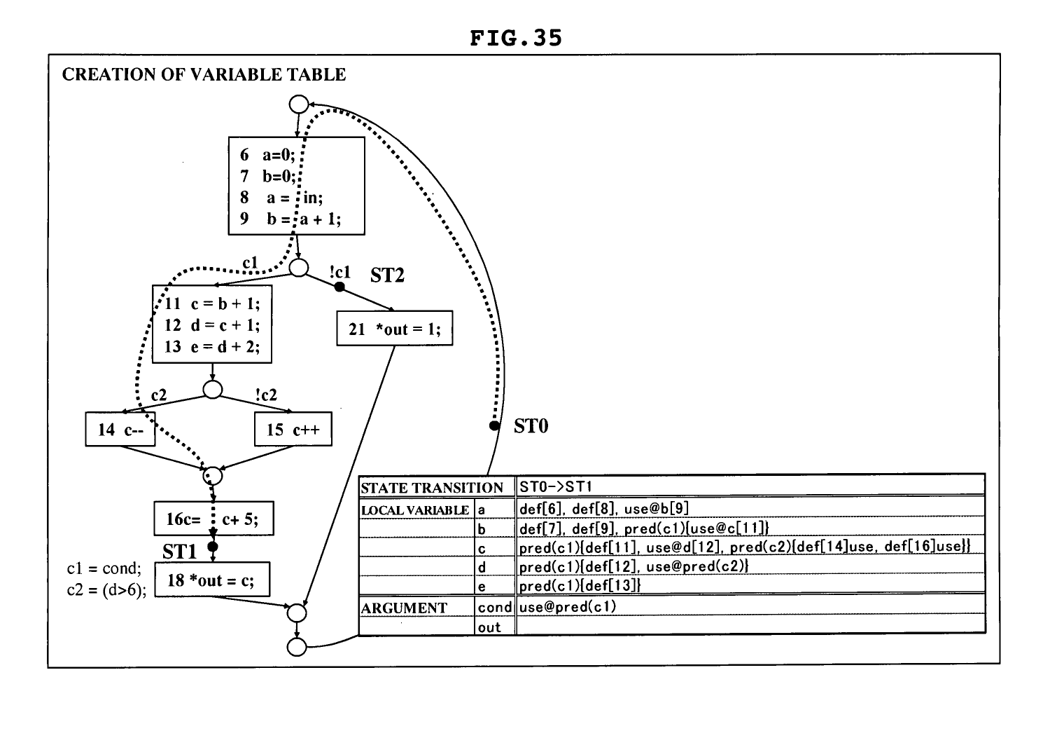

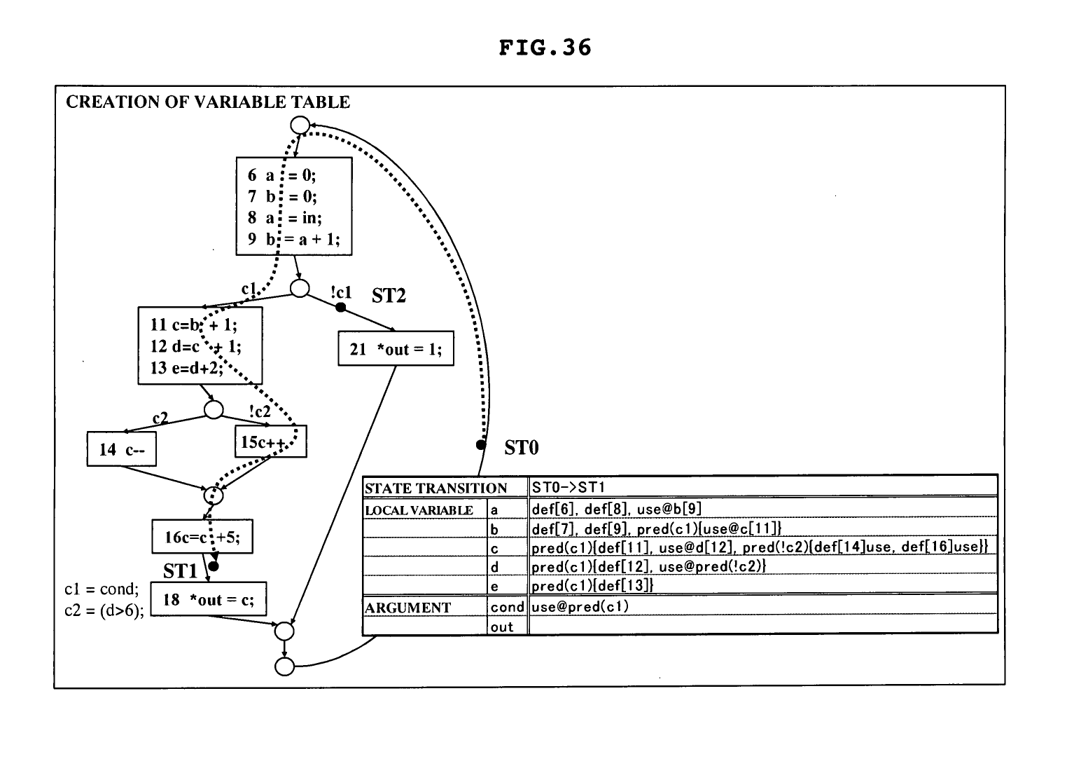

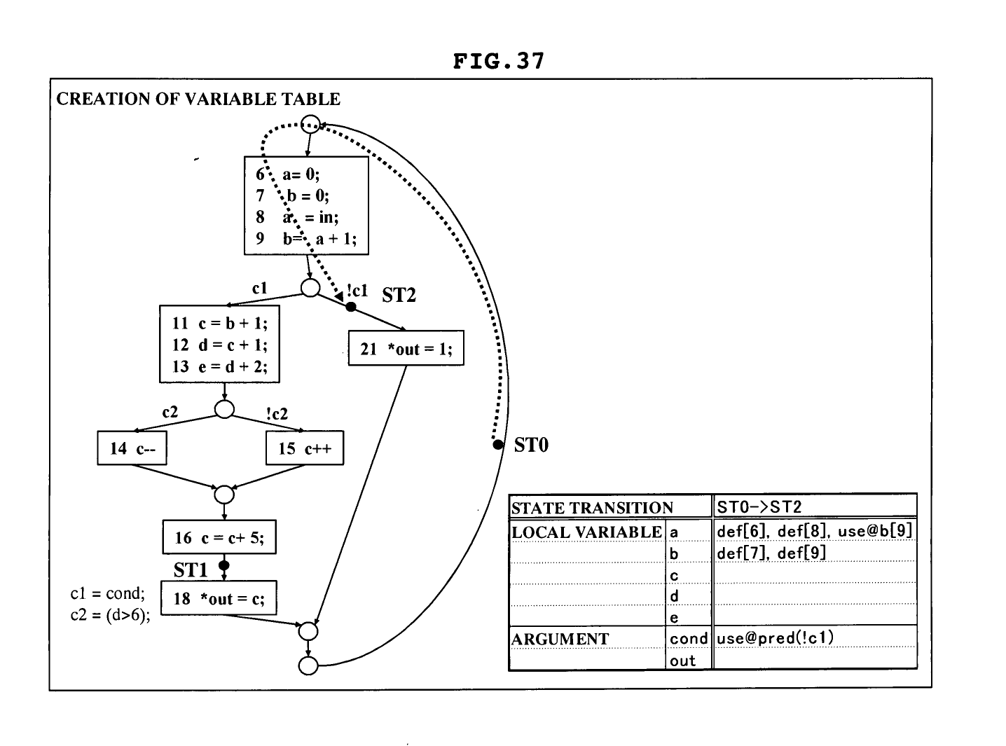

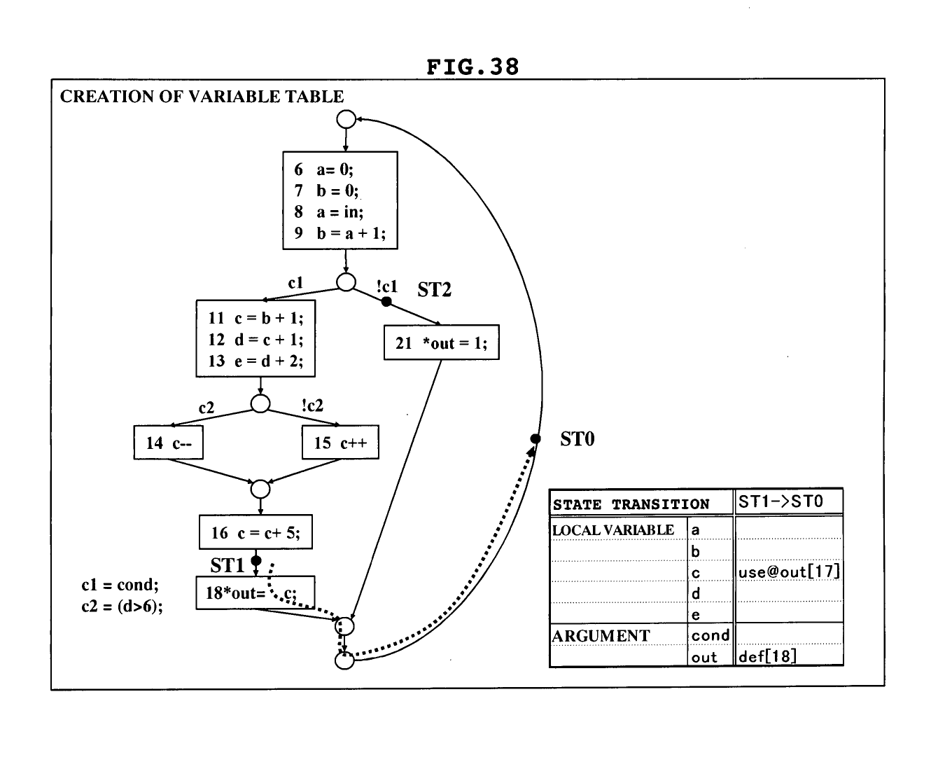

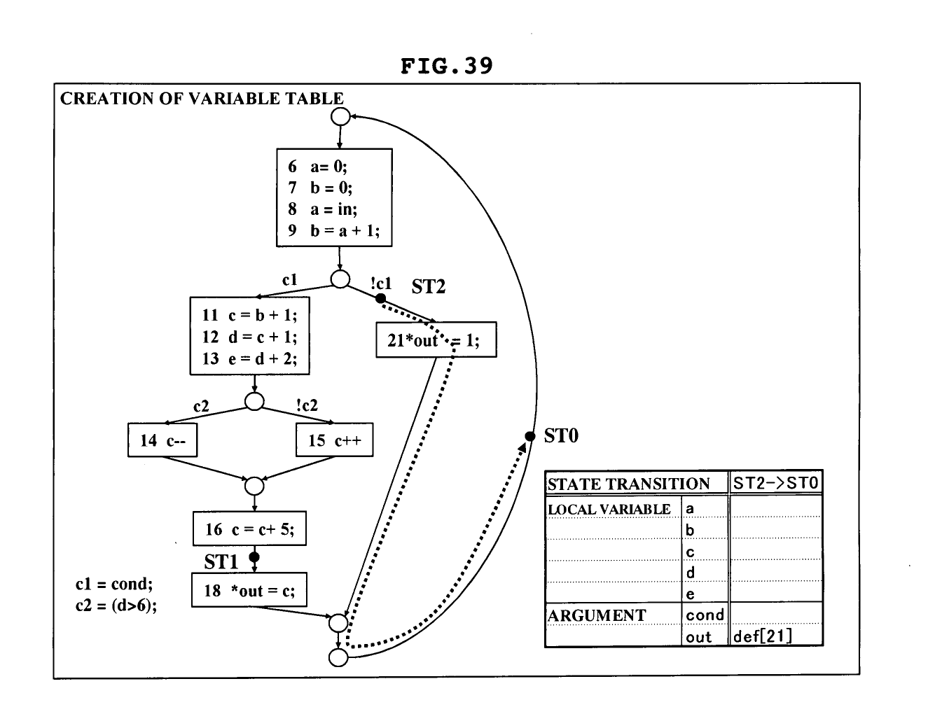

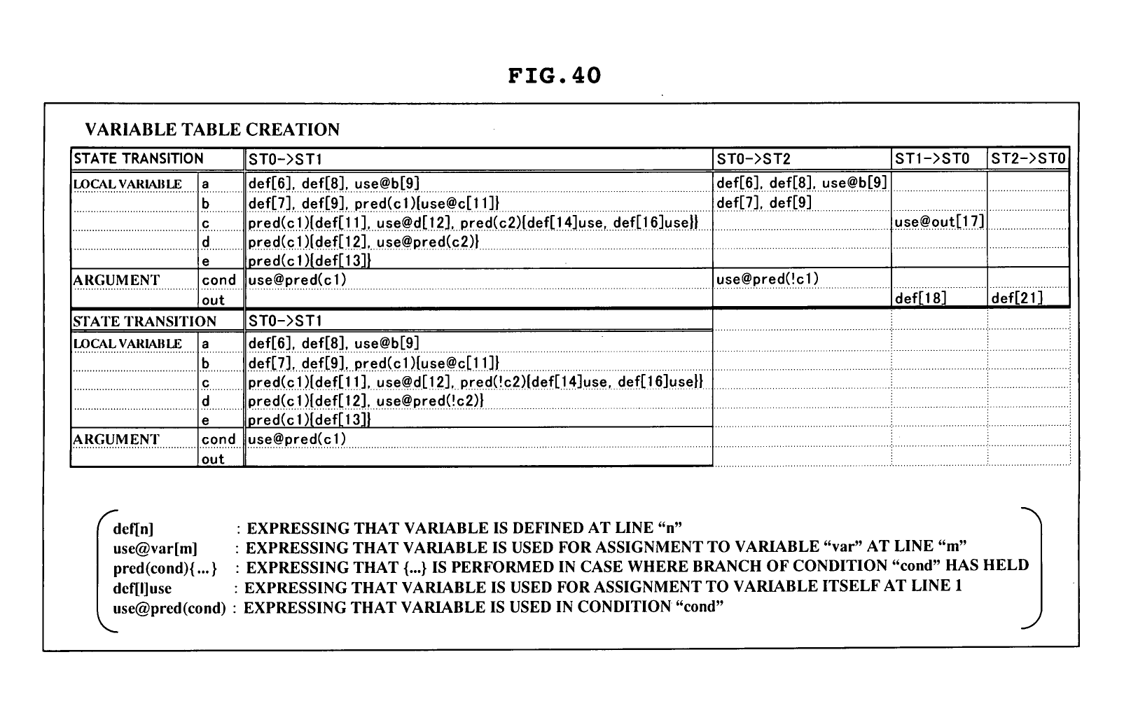

FIGS. 35 through 40 exemplify the situation of a variable table creation process for the state machine generation, in due course. The creation of a variable table conforms to the following procedure of steps (1)-(3): (1) Local variables are acquired, (2) the arguments of a function are acquired, and (3) the CFG is traced to a lower level side from an assigned state till arrival at a state, thereby to identify a state transition and to acquire the information of the definitions and references of the variables. When a loop whose both ends are not clock boundaries has been found out at this stage, the detection of a zero-cycle loop is decided and is notified to a user, whereupon the process is ended. The appearance of the zero-cycle loop signifies that a loop circuit formed of a combinational circuit exists in a circuit to-be-generated, and the existence of the loop circuit signifies that a serious mistake is involved in the circuit to-be-generated. Exemplified in FIG. 35 are local variables and arguments in one state transition from a state ST0 to a state ST1. Exemplified in FIG. 36 are local variables and arguments in another state transition from the state ST0 to the state ST1. Exemplified in FIG. 37 are local variables and arguments in a state transition from the state ST0 to a state ST2. Exemplified in FIG. 38 are local variables and arguments in a state transition from the state ST1 to the state ST0. Exemplified in FIG. 39 are local variables and arguments in a state transition from the state ST2 to the state ST0. A variable table exemplified in FIG. 40 is generated on the basis of the local variables and the arguments which have been obtained in the respective state transitions shown in FIGS. 35 through 39. In the descriptions of the variable table in FIG. 40:
Def[n] expresses that the variable is defined at Line “n”;
use@var[m] expresses that the variable is used for an assignment to a variable “var” at Line “m”;
pred(cond){ . . . } expresses that { . . . } is performed in a case where the branch of a condition “cond” has held;
def[1]use expresses that the variable is used for an assignment to the variable itself at Line 1; and
use@pred(cond) expresses that the variable is used in the condition “cond”.

The optimization process is performed on the basis of, for example, the variable table in FIG. 40. One aspect of the optimization process is the deletion of a redundant statement.

As the deletion of the redundant statement, in the first place, in a case where at least two descriptions “def”s exist within the column of the state transition for an identical variable, the following processing step 1) or 2) is executed:

1) A substep 1-1) or 1-2) to be explained below is executed up to this side of the description “pred(cond){ . . . }” existing posteriorly to the descriptions “def” (irrespective of the existence or nonexistence of the description “pred(cond){ . . . }”). 1-1): In a case where the description “def” accompanied by the description “use” does not exist posteriorly to the description “def”, only a statement corresponding to the last description “def” is left. 1-2): In a case where the description “def” accompanied by the description “use” exists posteriorly to the description “def”, only the description “def” not accompanied by the description “use” is left if it exists posteriorly to the description “def” accompanied by the description “use”, and the description “def” accompanied by the description “use” and the description “def” anterior to the description “def” accompanied by the description “use” are left else. This is iterated until no change comes to occur, and only statements corresponding to the left descriptions “def”s are left.

2) If the description “pred(cond){ . . . }” does not exist posteriorly to the descriptions “def”s, the processing step is ended, and if it exists, a substep 2-1) or 2-2) to be explained below is executed. 2-1) In a case where the condition of the description “pred(cond){ . . . }” refers to the result of the description “def”, the processing step is ended. 2-2) In a case where the condition of the description “pred(cond){ . . . }” does not refer to the result of the description “def”, a branch to the processing step 1) is done.

As the deletion process for the redundant statement, in the second place, the variable as to which the description “use” does not exist in any state transition is deleted.

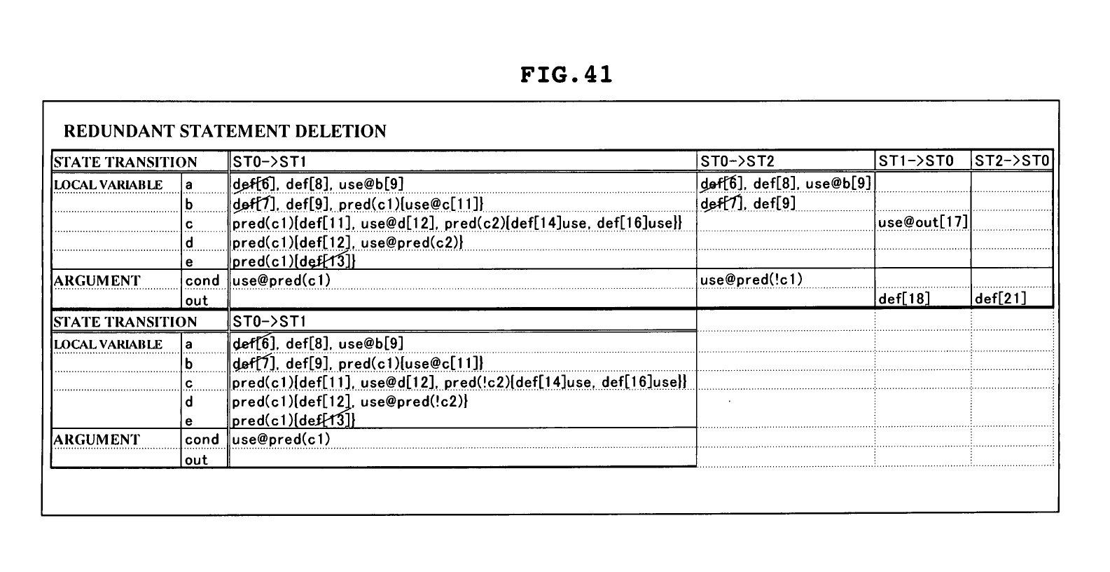

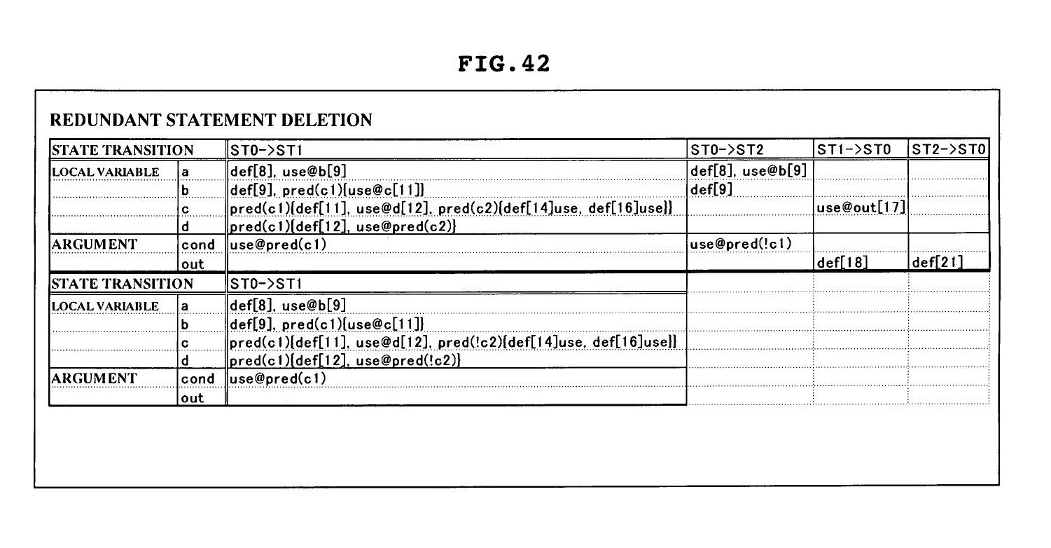

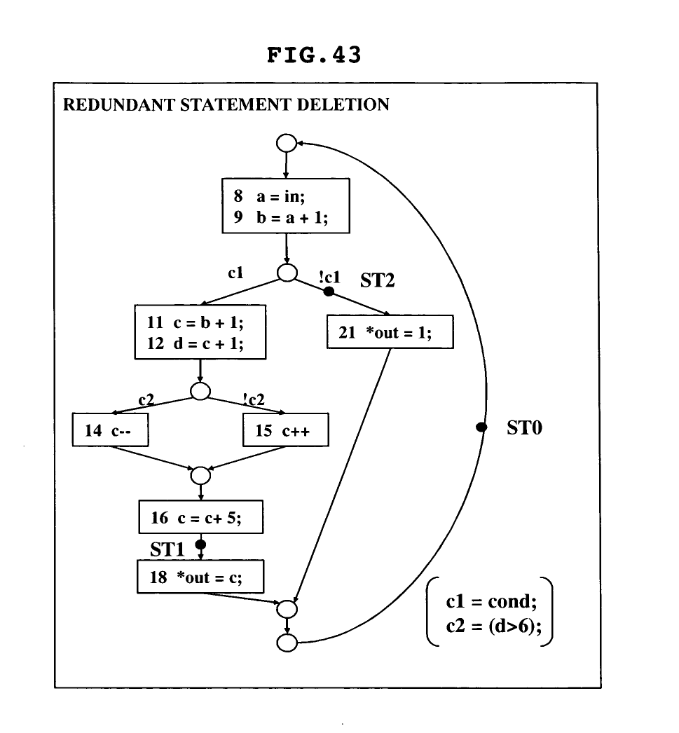

In the redundant statement deletions for the variable table in FIG. 40 as based on the above processing procedure, the statements to be deleted are shown in FIG. 41. In this figure, the statements to be deleted are clearly indicated by oblique lines. The variable table of a result obtained by deleting the redundant statements is exemplified in FIG. 42. The result obtained by deleting the redundant statements is expressed by a CFG in FIG. 43.

Another aspect of the optimization process is the deletion of any local variable. As the deletion process for the local variable, in the first place, each of the following processing steps 1)-3) is executed rightwards sequentially until no change comes to occur, in the state transition column of each variable:

1) In a case where the description “use” exists posteriorly to the description “def” without holding the description “pred(cond){ . . . }” therebetween, a substep 1-1), 1-2), 1-3) or 1-4) is performed. 1-1): In a case where the description “use” itself is the description “use@pred”, an assignment operation is executed, and the description “def” is deleted. 1-2): In a case where a variable in the description “@” is the local variable and where it is used as the description “use@pred”, an assignment operation is not executed. 1-3): In a case where a variable in the description “@” is a local variable and where it is not used as the description “use@pred”, an assignment operation is executed, and the description “def” is deleted. 1-4): In a case where a variable in the description “@” is an argument, an assignment operation is executed, and the description “def” is deleted.

2) In a case where the description “use” exists posteriorly to the description “def” with the description “pred(cond){ . . . }” held therebetween, and where a variable used in the condition of the description “pred(cond){ . . . }” is an argument, the substeps 1-1) through 1-4) are applied.

3) In a case where the description “use” exists posteriorly to the description “def” with the description “pred(cond){ . . . } ” held therebetween, and where a variable used in the condition of the description “pred(cond){ . . . }” is the local variable, a substep 3-1) or 3-2) is performed. 3-1): In a case where the condition of the description “pred(cond){ . . . }” does not refer to the result of the description “def”, the substeps 1-1) through 1-4) are applied. 3-2): In a case where the condition of the description “pred(cond){ . . . }” refers to the result of the description “def”, an assignment operation is not executed.

As the deletion process for the local variable, in the second place, the variable as to which the description “def” does not exist in any state transition is deleted, and a CFG after an assignment operation is analyzed again, thereby to update a variable table.

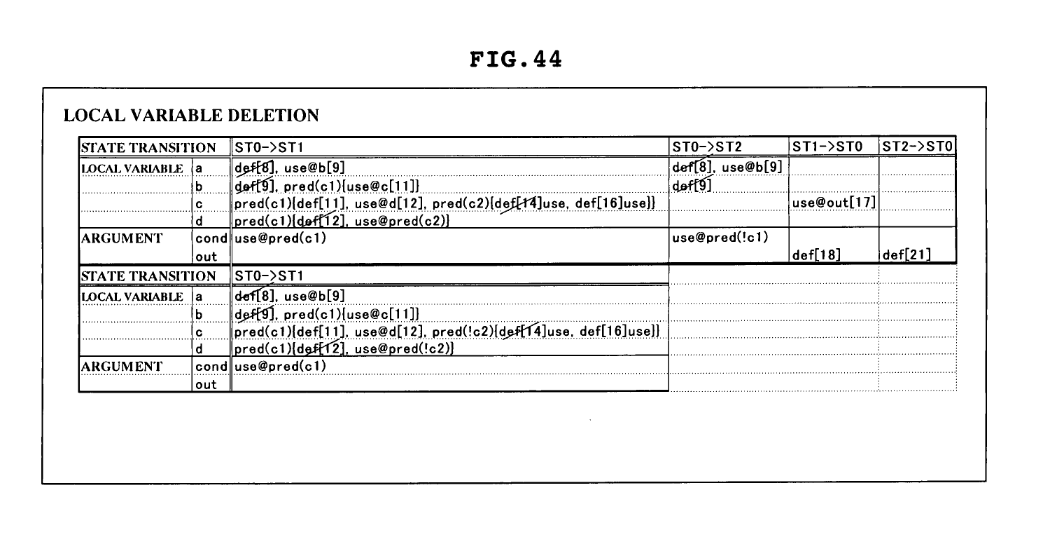

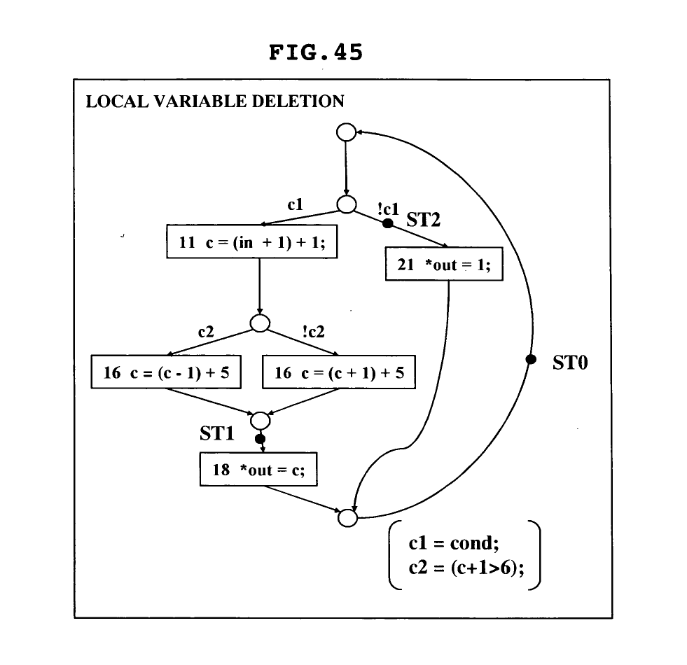

The variables to be deleted in the local variable deletions for the variable table in FIG. 42 are shown in FIG. 44. In this figure, the variables to be deleted are clearly indicated by oblique lines. A result obtained by the local variable deletion process is expressed as a CFG in FIG. 45.

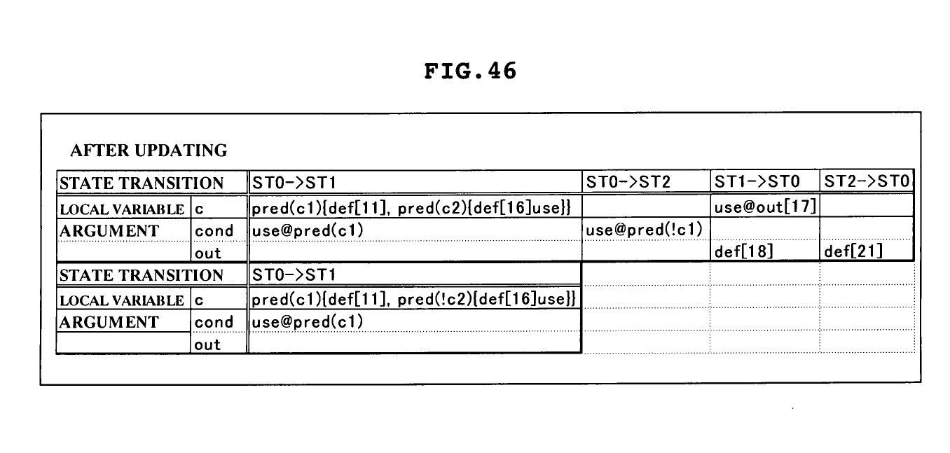

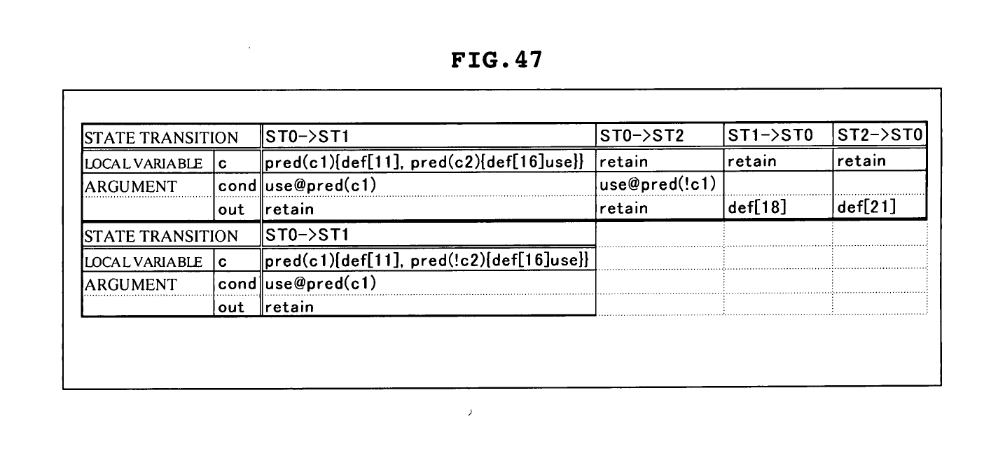

Exemplified in FIG. 46 is a variable table which has been finally updated by performing the redundant statement deletion process and the local variable deletion process. The required local variables are managed by the variable table. Referring to FIG. 46, it can be identified that the output variable and the local variable need to be retained in a part where the variable “def” does not exist. The reason therefor is that the output variable and the local variable must naturally be retained in the transition of the states. Accordingly, the necessity for the “retain” operation in that part becomes easily identifiable. As exemplified in FIG. 47, a description “retain” is added in the corresponding part by a “retain” analysis being a later process.

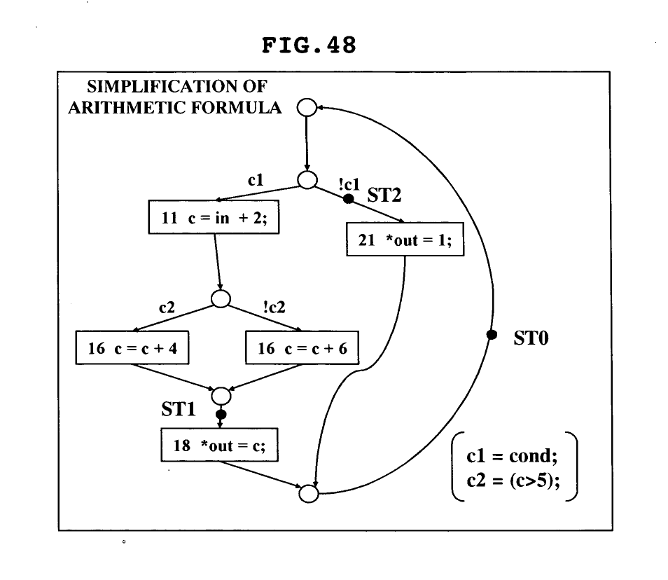

As the optimization of codes, the simplification of arithmetic formulae as exemplified in FIG. 48 is further performed.

<<State Machine Generation—Retain Analysis>>

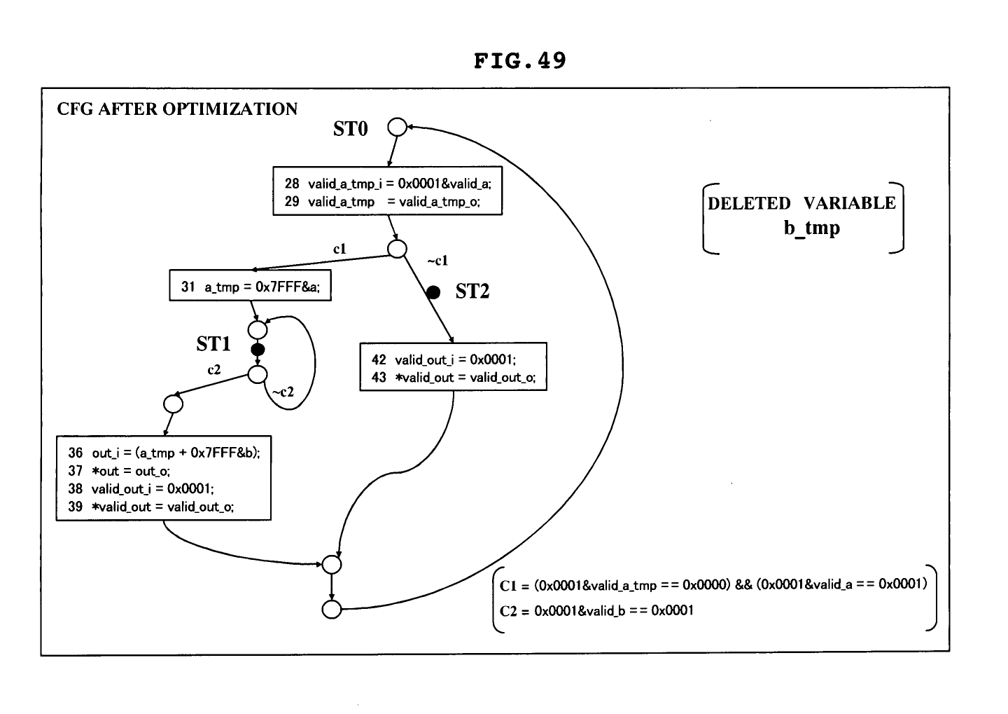

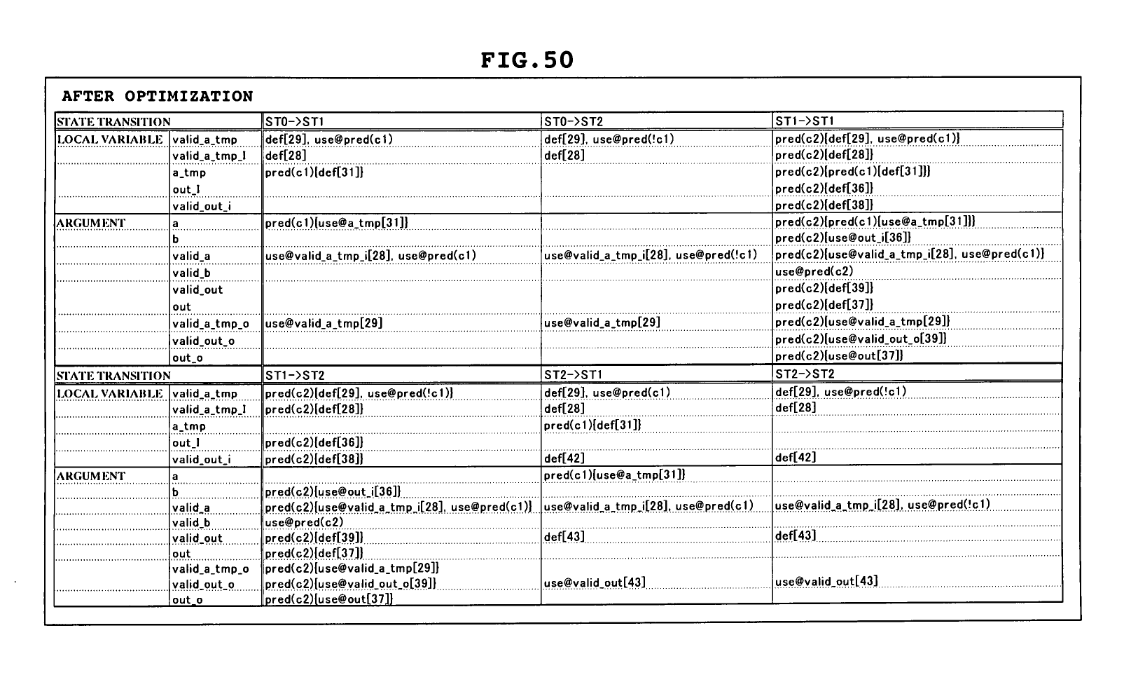

Now, the description shall refer again to the example of the circuit design which satisfies the specifications in FIGS. 2 and 3. In FIGS. 32 through 48, the process of the code optimization has been illustrated using the other example which has been especially simplified. After the state assignment shown in FIG. 31, a similar optimization process is performed, whereby a CFG after the optimization as shown in FIG. 49 can be obtained, and a variable table as shown in FIG. 50 can be obtained. The description “retain” is not explicitly indicated in the variable table in FIG. 50 after the optimization process. It is acquired by a “retain” analysis to be explained below.

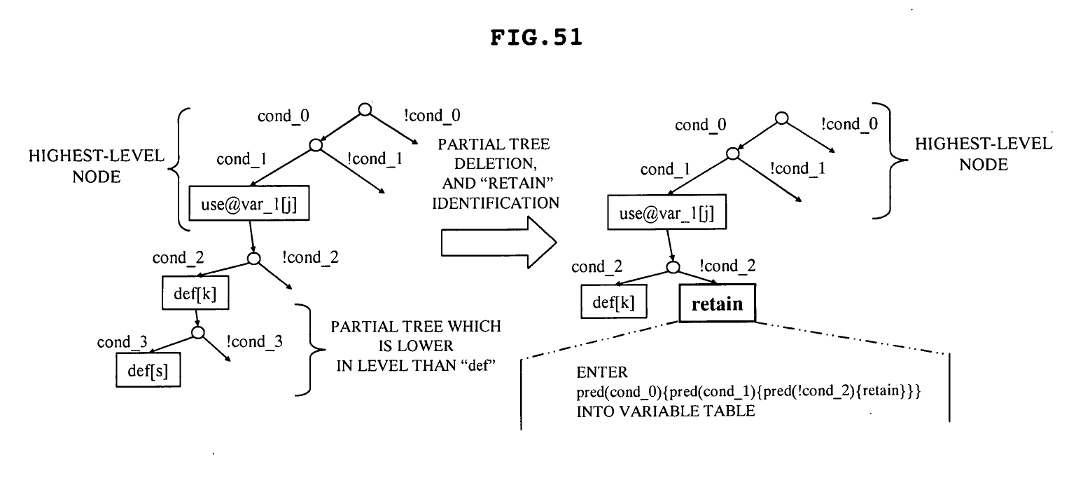

The algorithm of the “retain” analysis is exemplified in FIG. 51. Regarding the “retain” analysis, in a case where the description “def” does not exist for the output variable or the local variable at all in the column of the state transition, this output variable or local variable needs to be retained in the state transition. Besides, in a case where the description “pred( )” is affixed even in the existence of the description “def”, a diagram as shown in FIG. 51 is created for the state transitions of individual output variables and local variables, so as to identify a part which requires the “retain” operation in a branch based on the description “pred( )”. Especially for the local variables which have been added anew by the register assignment statement identifying process, if the “retain” operation is required is analyzed for only the variables which bear information “_i”. Besides, even when the information “pred( )” does not exist in the variable table, it is affixed if necessary, by analyzing the CFG again.

The diagram shown in FIG. 51 is created by creating a tree which has the nodes of the descriptions “use”, “def” etc. with the condition of the description “pred( )” as the branch. Besides, a partial tree which is lower in level than the description “def” of the tree is deleted, and that node except the highest-level node as to which the description “def” does not exist in the lower-level nodes thereof is identified as a node which needs to be retained.

Here, the “highest-level node” signifies all of nodes to the node of the description “def” or “use” at the shortest distance from the root of the tree, and the brother nodes thereof.

In a case, for example, where the information of the variable “var” in the state transition STn−>STm as based on a variable table is pred(cond_{—}0){pred(cond_{—}1){use@var_{—}1} [j], pred(cond_{—}2){def[k], pred(cond_{—}3){def[s]}}}, the diagram becomes as shown in FIG. 51.

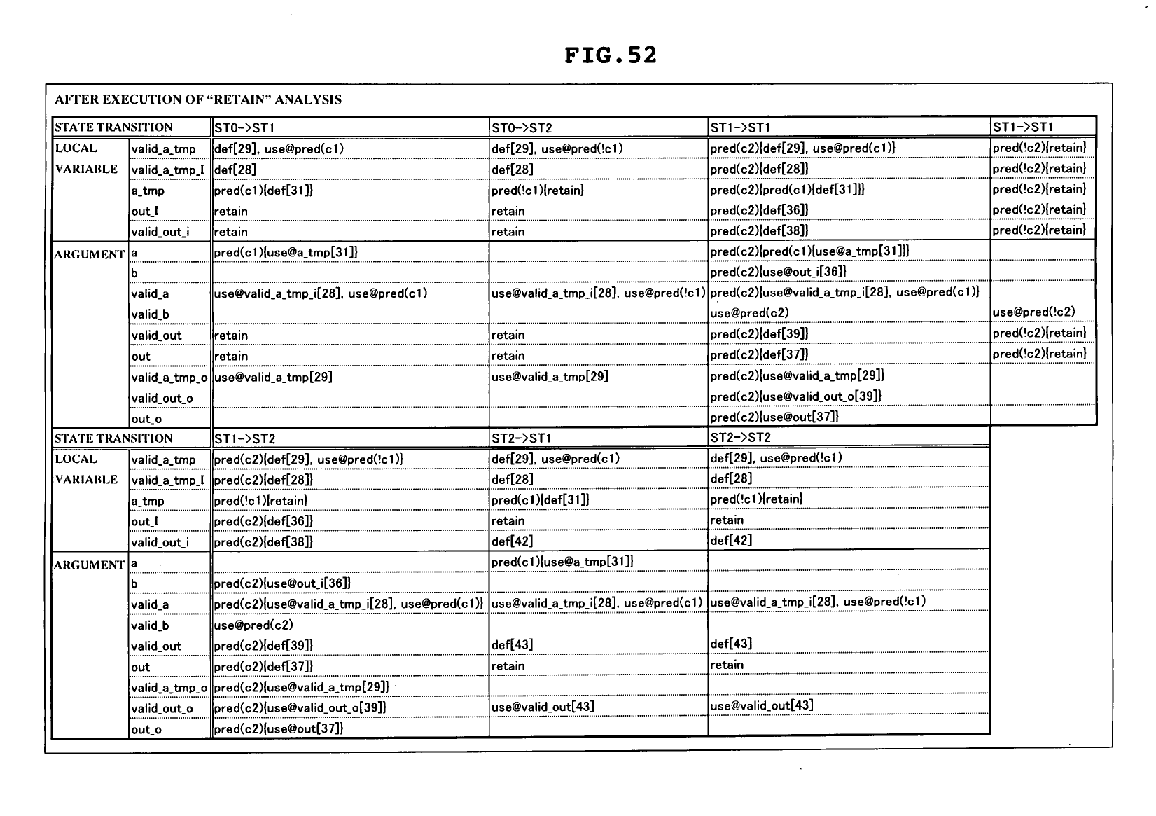

Exemplified in FIG. 52 is a variable table which corresponds to the result of the “retain” analysis. The descriptions “retain” are added to the parts which need to be retained.

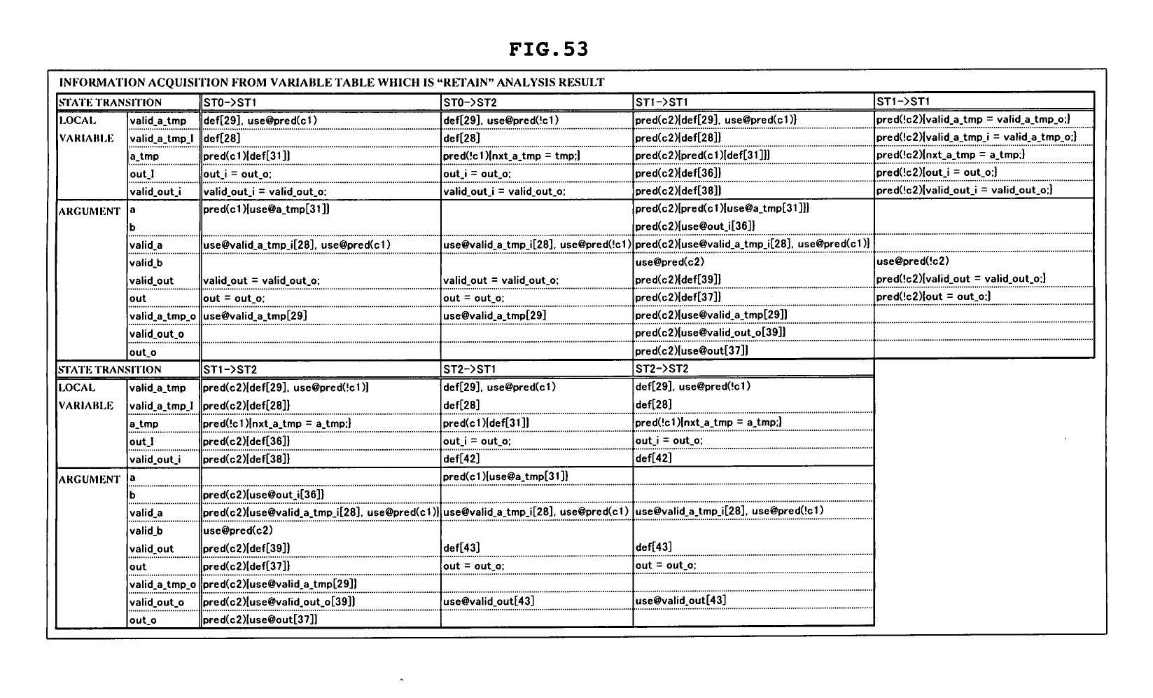

Actual codes which are to be added to the parts “retain” in the variable table can be acquired from the variable table. More specifically, in a process for information acquisition from the variable table of the “retain” analysis result, output variables and local variables as to which the information “retain” is inserted in the columns of the variable table are acquired. By way of example:
1) in case of a variable at the left hand of the register assignment statement, a variable name is stored as sig=sig_o;
2) in case of a variable which has been added in the register assignment statement identifying part and which bears the information “_i”, a variable name is stored as sig_i=sig_o; and
3) in case of any other variable, a variable name is stored as nxt_sig=sig.
   Especially in a case where the description “pred( )” is affixed to the information “retain”, for example, in a case where the variable corresponds to the case 3) and where the variable name is “sig” as inpred(cond_{—}0){pred(cond_{—}1){pred(!cond_{—}2){retain}}}, this variable is stored as pred(cond_{—}0){pred(cond_{—}1){pred(!cond_{—}2){nxt_sig=sig}}}. The above information is overwritten and registered in the variable table. Exemplified in FIG. 53 is a variable table in which the information items “retain” have been overwritten by the actual codes. Further, a variable bearing information “nxt_” as in “nxt_sig” is stored. In case of the example in FIG. 53, the variable bearing the information “nxt_” is only a variable “a_tmp”.

<<State Machine Generation—State Machine Extraction>>

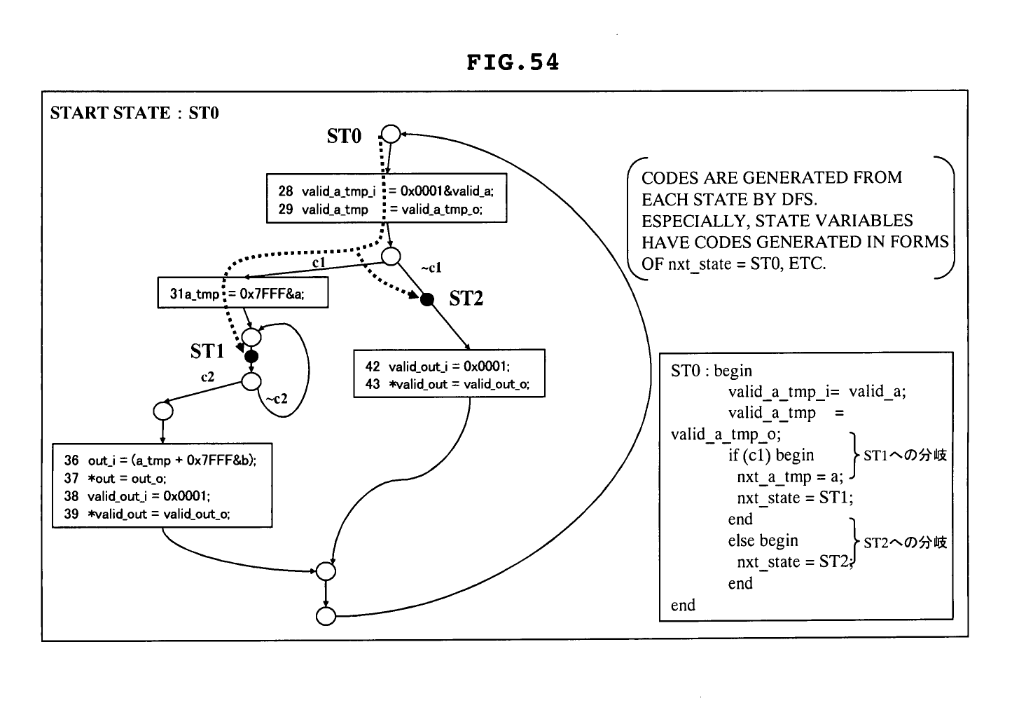

Next, the state machine extraction process S5D will be described. In the state machine extraction process S5D, search is made by the depth-first search from each assigned state till arrival at a clock boundary, namely, at a state which is not an initial state, the information of a node which is not any of a loop, a conditional branch and a label branch obtained by the search is acquired, and the acquired information is merged with the “retain” information of the variable table, thereby to extract a state machine for use in a HDL description. An example of a start state ST0 is shown in FIG. 54. Although the descriptions of states are not especially restricted, codes are generated by the DFS from the individual states. In this case, the codes are generated by bringing state variables into the forms of “nxt_state=ST0”, etc.

Especially, regarding the variable to which the description “nxt_”has been affixed by the “retain” information, the state machine for the HDL description is extracted using a variable name bearing the description “nxt_”, not the original variable name. Besides, the “&” operation between a signal and a constant has been used for the bit width analysis and has become unnecessary, so that it is deleted. Incidentally, the constant is converted into the binary notation of HDL in consideration of the number of bits of the left hand of an input, so as to conform to the HDL description.

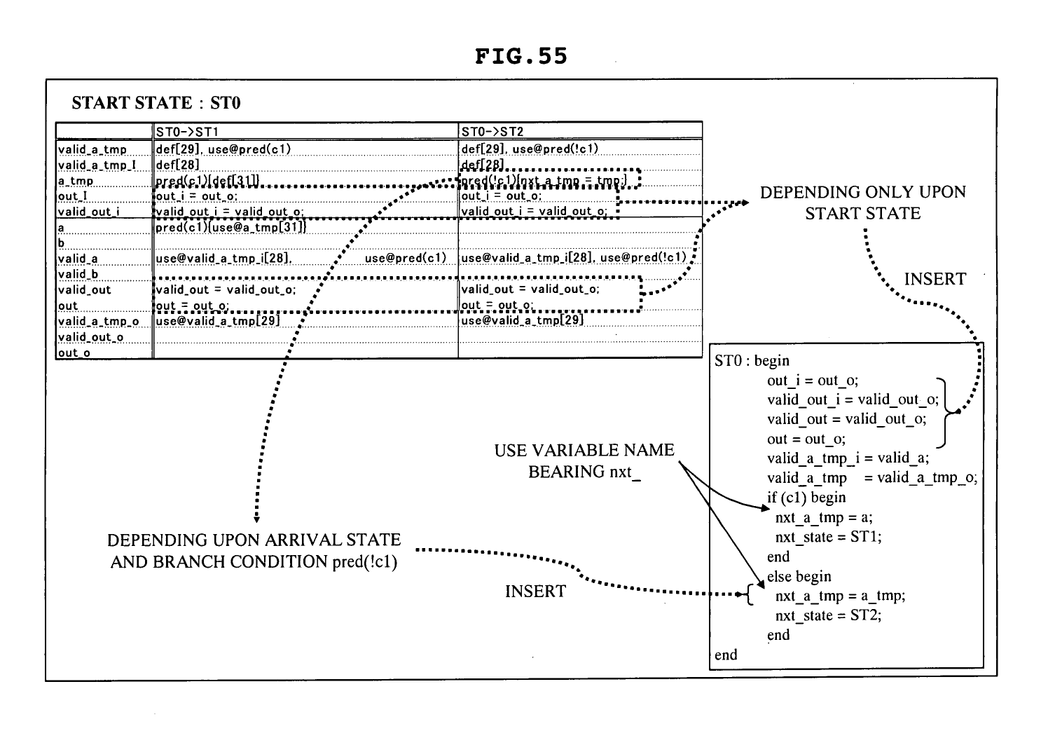

In the acquisition of the “retain” information of the variable table, from among individual state transition columns, there are acquired all columns in which the same state as at the start of the depth-first search is a start state, and it is identified whether the “retain” information depends only upon the start state or also upon an arrival state, or it depends upon the arrival state and a branch condition. Except in a case where the “retain” information depends only upon the start state, the description “pred( )” of the “retain” information is compared with the branch condition of the CFG, whereby an assignment formula stored in the variable table is inserted into the appropriate position of the HDL code as the “retain” information. Exemplified in FIG. 55 is a situation where the codes conforming to the “retain” information items are extracted from the variable table and are utilized for the extraction of the state machine.

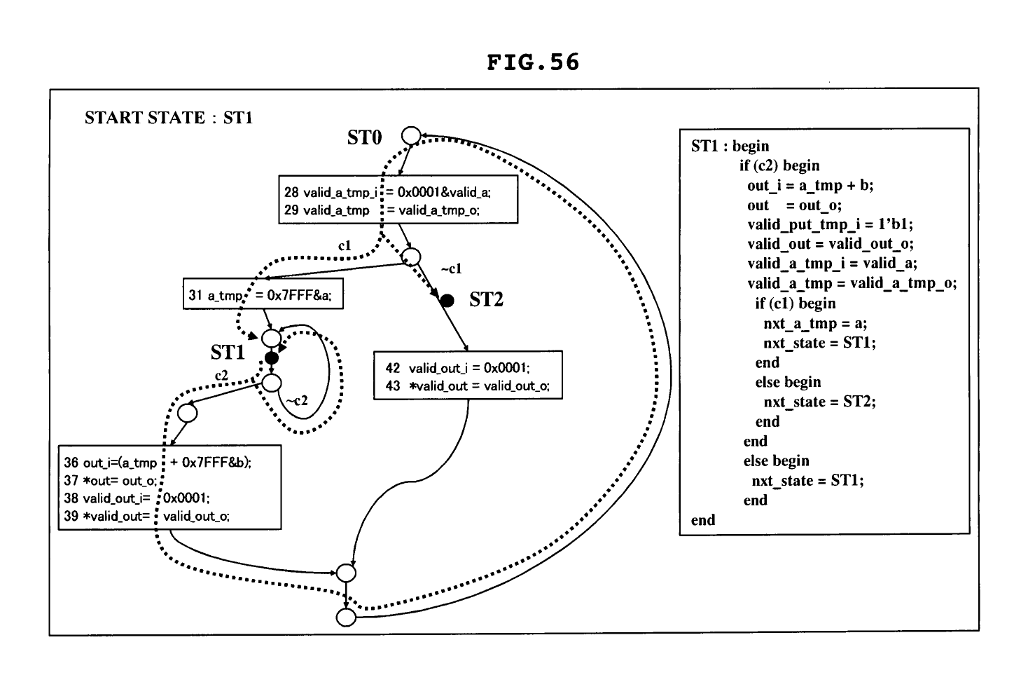

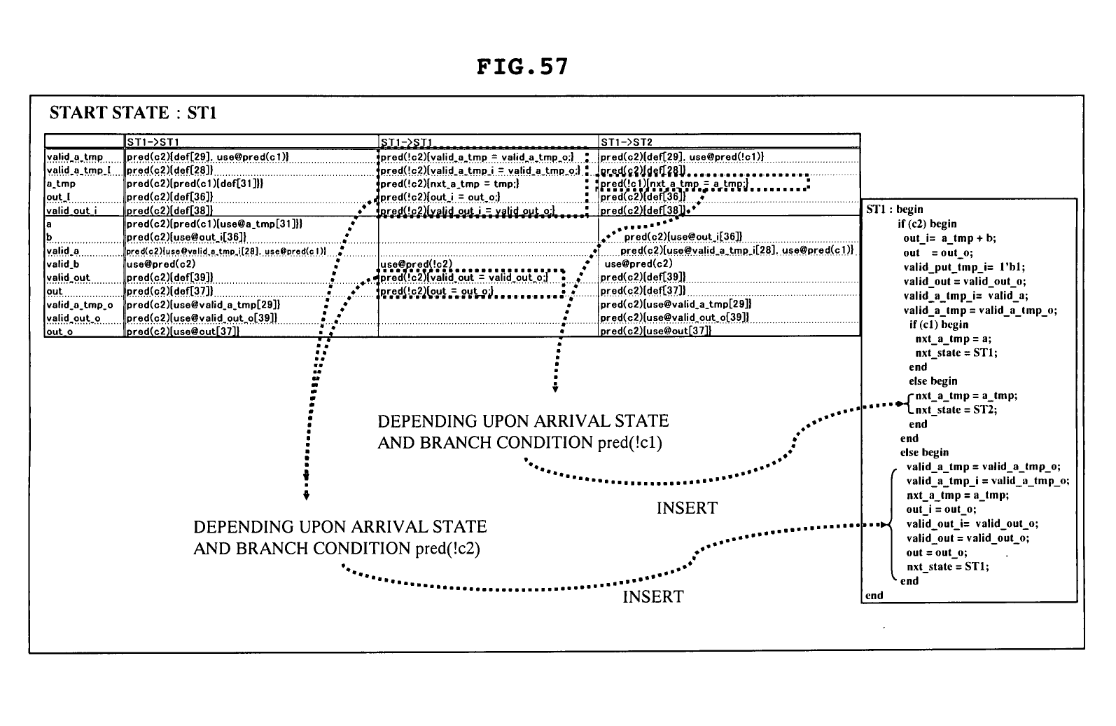

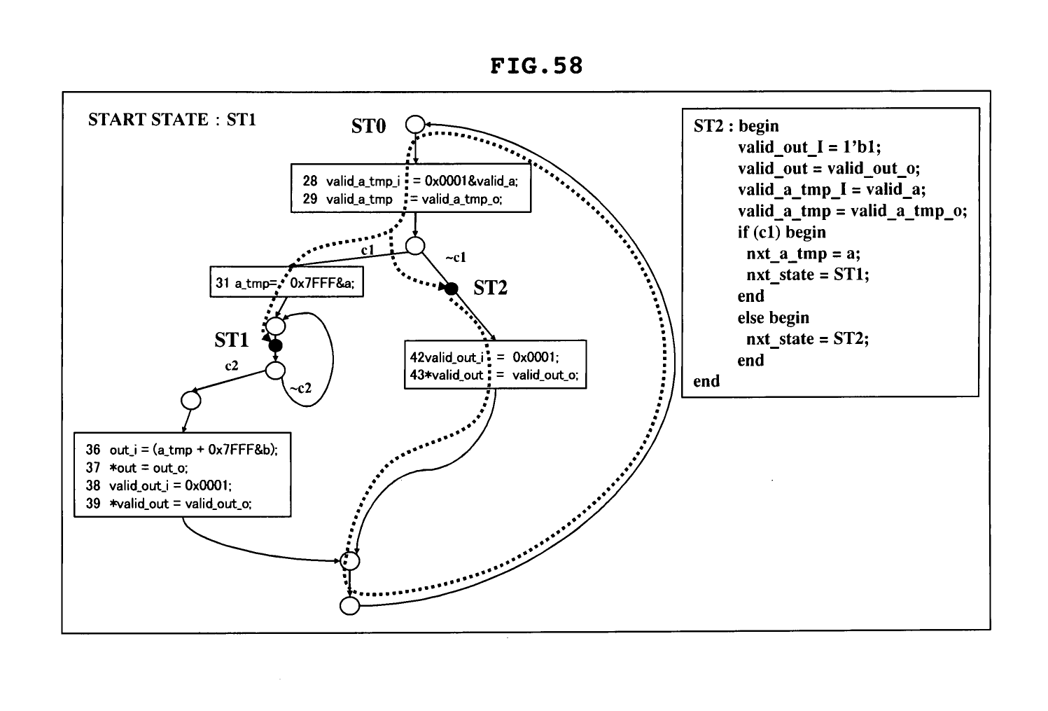

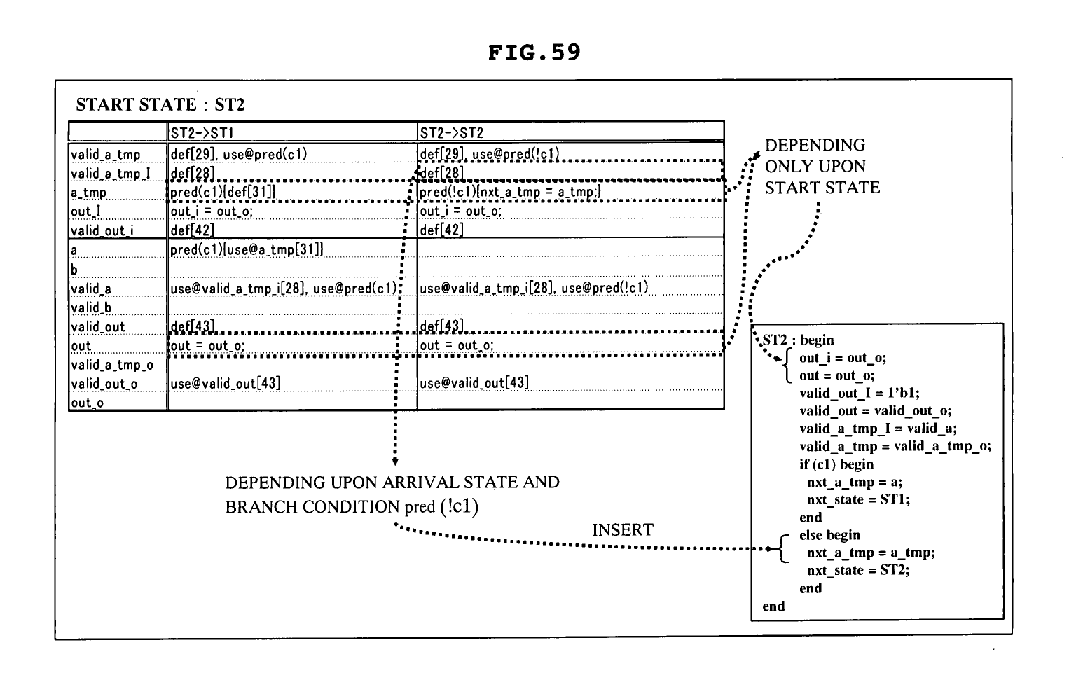

Acquired examples of state machine descriptions conforming to the HDL description, in the start state ST0 are shown in FIGS. 54 and 55. Acquired examples of state machine descriptions conforming to the HDL description, in a start state ST1 are shown in FIGS. 56 and 57. Acquired examples of state machine descriptions conforming to the HDL description, in a start state ST2 are shown in FIGS. 58 and 59.

<<HDL Description Generation Process>>

In the HDL description generation process S6, a module declaration generates an HDL description which is obtained in such a way that symbols * expressive of a type and a pointer are deleted from a function declaration in the C description as contains the circuit operation description part, and that descriptions “clk” and “reset_n” are added to the resulting declaration. An input/output declaration is generated as an HDL description in such a way that a variable which is an argument in the function declaration and which exists only at the left hand of an assignment formula is set as an output, while a variable which exists only at the right hand of the assignment formula is set as an input, and the bit width of the HDL description is identified by the method explained in the descriptive contents of the C description. A “reg” declaration is generated as an HDL description together with the “reg” specification statement of the descriptions “clk” and “reset_n”, in such a way that variables finally left in the conversion processing thus far performed, and variables added in the conversion processing thus far performed are identified among the local variables stated in the C description. The HDL description of the “wire” declaration of a variable allotted to a branch condition in the CFG generation process is generated, so as to generate an HDL description which contains the assignment statement of the branch condition for the allotted variable. Also, the HDL description of a parameter specification statement for expressing an assigned state as a binary number is generated.

Besides, regarding register assignment statements, all the register assignment statements and variable declarations at the right hands thereof are acquired. Ina case, for example, where the acquired information items are:
unsigned char sig1_latched=0x00;
unsigned char sig2_latched=0x00;
unsigned short out;
sig1_latched=$ sig1&0x03;
sig2_latched=$ sig2&0x13;
out=$ exe_result&0x1FFF;

the following HDL descriptions are generated:

always @(posedge clk or negedge reset_n) begin

if (!reset_n) begin

sig1_latched_o <= 2′b00;
sig2_latched_o <= 3′b000;

end
else begin

| sig1_latched_o <= sig1_latched_i; | |
|---|---|
| sig2_latched_o <= sig2_latched_i; | |
| out_o | <= out_i; |

end

end

Subsequently, reference is had to the storage of a variable bearing the description “nxt_” as obtained in the state machine extraction part, and the declaration part of the variable is acquired. In case of this example, “a_tmp” is pertinent, and the declaration part is:
unsigned short nxt_a_tmp=0x0000

At the generation of the “reg” declaration description, the effective bit width has been known 15 bits from the assignment:
a_tmp=$ 0x7FFF&a

Therefore, the following description is generated:

always @(posedge clk or reset_n) begin

if (!reset_n) begin

state = ST0;
a_tmp = 15′b000000000000000;

end
else begin

state = nxt_state;
a_tmp = nxt_a_tmp;

end

end

Besides, the HDL descriptions of the extracted state machines are joined. For the left hands of the assignment statements in the respective states, statements are created in which corresponding variables of “_o” are assigned to the variables of the left hands of the register assignments and the variables added in the register assignment statement identifying part, while initial values are assigned to the other variables. Also, a statement “nxt_state=ST0” is created. Parts corresponding to the defaults of “case” statements are created, and they are also joined. The variables of the right hands, and the variables of “wire” declaration are arrayed through “or”s, thereby to generate the following description:

Always @(state or c1 or c2 or valid_a_tmp_i or valid_a_tmp_o
or valid_a_tmp or a_tmp or

valid_out_i or valid_out_o or out_i or out_o) begin

case(state[1:0])
endcase

end

The joined HDL descriptions are inserted between the “case” statements, and a description “endmodule” is affixed to the last line. Thus, the HDL description generation is completed. The Nos. of lines are merely added.

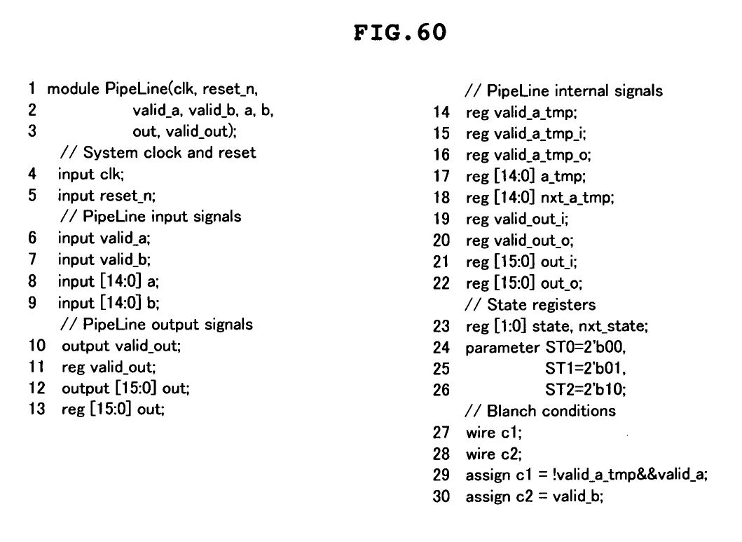

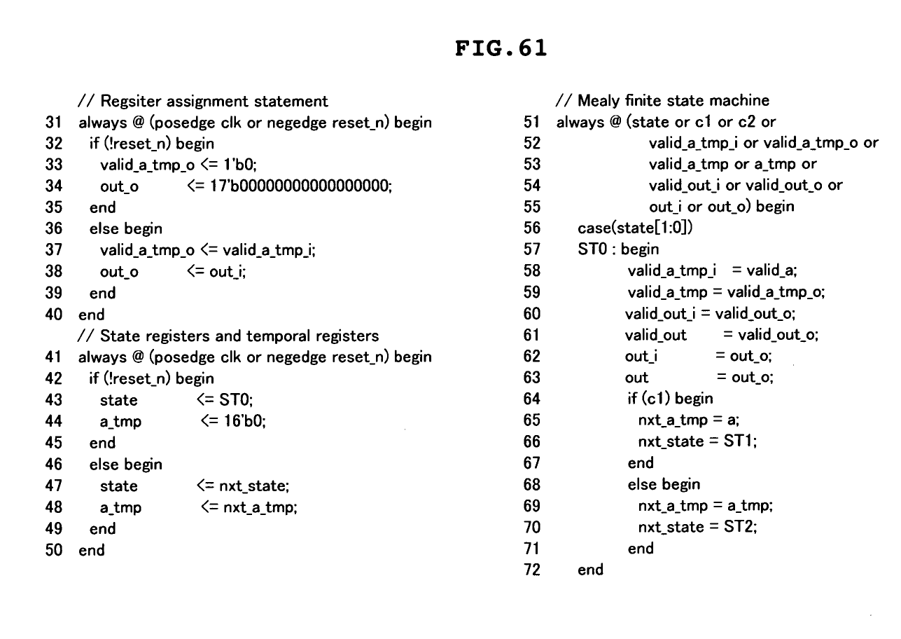

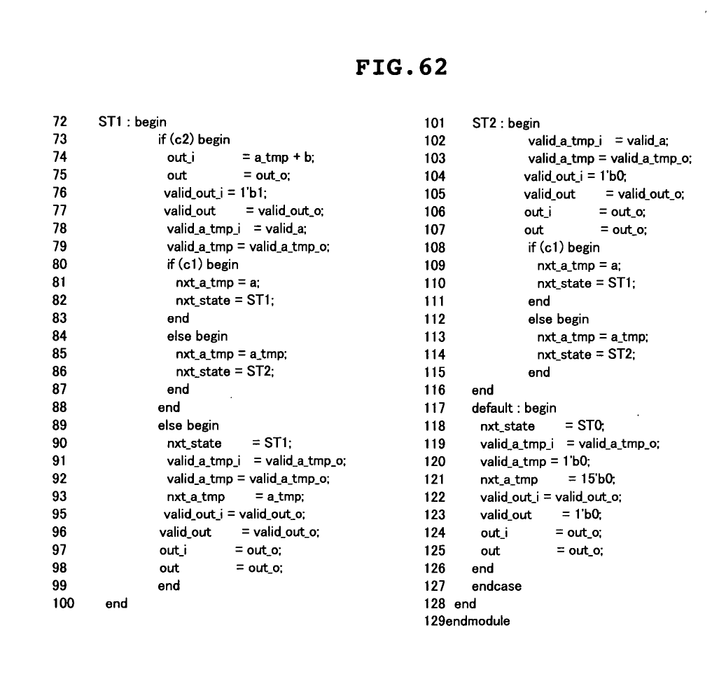

The HDL descriptions generated by the HDL description generation process S6 are exemplified in FIGS. 60 through 62.

According to the design method thus far elucidated, functions and advantages to be stated below are attained.

Pseudo C descriptions in which clock boundaries are explicitly inserted into C descriptions are input, thereby to realize parallel descriptions of statement level based on register assignment statements, so that a pipeline operation attended with a stall operation can be represented.

Since functions can be designed at a program level without caring about state machines, the quantity of descriptions is decreased, so that the design method contributes, not only to shortening the term of a development, but also to enhancing a quality.

Besides, it is permitted to describe a bus interface circuit and an arbitration circuit which cannot be represented by the general descriptions of program level as do not designate the clock boundaries. Especially, since register assignments are describable, descriptions can be made in consideration of parallelism at the statement level, and a complicated circuit operation such as the pipeline operation attended with the stall operation can be easily described with a smaller quantity of codes than in the C descriptions.

Besides, since the pseudo C descriptions are converted into the C descriptions which are compilable by a conventional C compiler, a high-speed simulation is realized, and the number of man-hour for verifying functions can be sharply diminished. In the function design, accordingly, sharp diminutions in the number of man-hour are realized in both the logic design and the logic verification.

The design method is applicable to the development of, for example, a cache controller or a DMA controller of which a cycle precision is required and for which a high-level synthetic tool is unsuitable, and it is greatly contributive to shortening the term of the design.

Although the invention made by the inventors has been concretely described above in conjunction with the embodiments, the present invention is not restricted thereto, but it is, of course, variously alterable within a scope not departing from the purport thereof.

By way of example, the program descriptions and circuit descriptions explained before are merely exemplary, and they can be applied to various logic designs. The HDL is not always restricted to the RTL. The program description language is not restricted to the C language, but it may well be any other high-class language. Further, it is possible to employ a virtual machine language such as “Java” (registered trademark).

The present invention is extensively applicable to the design of a CPU and the like logic circuits.

1. A compiler comprising:
a conversion program,
wherein the conversion program can convert first program descriptions described by diverting a predetermined program language into circuit descriptions,
the first program descriptions contain register assignment statements with particular operators and clock boundary descriptions, and which permit circuit operations to be specified at a cycle precision, and
the circuit descriptions specify hardware realizing the circuit operations specified by the first program descriptions in a predetermined hardware description language.

2. A compiler comprising:
a conversion program,
wherein the conversion program can convert first program descriptions described by diverting a predetermined program language can be converted into second program descriptions using a predetermined program language,
the first program descriptions contain register assignment statements with particular operators and clock boundary descriptions, and which permit circuit operations to be specified at a cycle precision, and
the second program descriptions contain transformed assignment statements into which the register assignment statements are transformed in order to make states of preceding cycles referable, and register assignment description insertion statements which associate variables of the transformed assignment statements with changes of registers attendant upon cycle changes, in correspondence with the clock boundary descriptions.

3. A compiler comprising:
a conversion program,
wherein the conversion program can convert first program descriptions described by diverting a predetermined program language into second program descriptions using a predetermined program language,
the first program descriptions contain register assignment statements with particular operators and clock boundary descriptions, and which permit circuit operations to be specified at a cycle precision,
the second program descriptions contain transformed assignment statements into which the register assignment statements are transformed in order to make states of preceding cycles referable, and register assignment description insertion statements which associate variables of the transformed assignment statements with changes of registers attendant upon cycle changes, in correspondence with the clock boundary descriptions, and
the circuit descriptions specify hardware which is defined by the second program descriptions, in a predetermined hardware description language.

4. The compiler of claim 1, wherein the predetermined program language is a C language.

5. The compiler of claim 1, wherein the hardware description language is a description language of RTL level.

6. A logic circuit design method comprising:
a first step; and
a second step,
wherein the first step inputs first program descriptions which contain register assignment statements and clock boundary descriptions bearing peculiar operators, which are described by diverting a predetermined program language in order to define circuit operations on the basis of timing specifications, and which permit the circuit operations to be specified at a cycle precision, and
the second step generats circuit information which satisfies the timing specifications, on the basis of the first program descriptions.

7. The logic circuit design method of claim 6, wherein the second step comprises the step of converting the first program descriptions, and generating as the circuit information, second program descriptions containing descriptions into which the register assignment statements are transformed using input variables and output variables, and which assign the input variables to the output variables in correspondence with the clock boundary descriptions.

8. The logic circuit design method of claim 7, wherein the second step comprises the step of converting the second program descriptions, and generating as the further circuit information, circuit descriptions which serve to specify hardware satisfying the timing specifications, in a predetermined hardware description language.

9. The logic circuit design method of claim 8, wherein the program language is a C language.

10. The logic circuit design method of claim 9, further comprising the third step of performing a simulation of a circuit to-be-designed by employing the second program descriptions.

11. The logic circuit design method of claim 6, wherein the second step comprises the step of converting the first program descriptions, and generating as the circuit information, second program descriptions containing descriptions into which the register assignment statements are transformed using input variables and output variables.

12. The logic circuit design method of claim 11, wherein the second step comprises the step of converting the second program descriptions, and generating as the circuit information, third program descriptions containing descriptions which assign the input variables to the output variables in correspondence with the clock boundary descriptions, and being described in a predetermined program language so as to be executable by a computer.

13. The logic circuit design method of claim 12, further comprising the third step of performing a simulation of a circuit to-be-designed by employing the third program descriptions.

14. The logic circuit design method comprising:
an input step; and
conversion step,
Wherein the input step inputs first program descriptions which contain register assignment statements and clock boundary descriptions bearing peculiar operators, which are described by diverting a predetermined program language in order to define circuit operations on the basis of timing specifications, and which permit the circuit operations to be specified at a cycle precision, and
the conversion step generates second program descriptions containing descriptions into which the register assignment statements are transformed using input variables and output variables and which assign the input variables to the output variable in correspondence with the clock boundary descriptions, and being described in the predetermined program language.

15. The logic circuit design method of claim 14, wherein, in course of generating a CFG on the basis of the first program descriptions, the conversion step sets clock boundary nodes in the CFG in correspondence with the clock boundary descriptions, whereupon it inserts the register assignment descriptions behind the clock boundary nodes.

16. The logic circuit design method of claim 15, further comprising an optimization step of optimizing codes of the second program descriptions, while a variable table of respective state transitions is being created by utilizing the CFG.

17. The logic circuit design method of claim 16, further comprising a “retain” step of extracting parts in which variables do not change between states within the variable table, as parts which need to be retained, and adding descriptions for assigning the input variables to the output variables, to the extracted parts.

18. The logic circuit design method of claim 17, further comprising an extraction step of extracting the codes which constitute state machines, on the basis of the variables and arguments of the respective state transitions within the variable table having undergone said “retain” step.

19. The logic circuit design method of claim 18, further comprising the step of describing hardware of a circuit which satisfies the circuit specifications, in a predetermined hardware description language, while reference is being had to the state machine constituting codes extracted by said extraction step, and to the second program descriptions.

20. The logic circuit design method of claim 14, wherein, whether or not a loop to be executed in the 0th cycle is existent is decided for the first program descriptions, and when the loop has been decided to be nonexistent, the step of describing hardware of a circuit which satisfies the circuit specifications, in a predetermined hardware description language, is performed.
